(19) United States
(12) Patent Application Publication
(10) Pub. No.: US 2025/0061704 A1
(43) Pub. Date: Feb. 20, 2025

(54) STORAGE MEDIUM STORING COMPUTER PROGRAM AND INSPECTION APPARATUS

(71) Applicant: BROTHER KOGYO KABUSHIKI KAISHA, Nagoya (JP)

(72) Inventor: Koichi SAKURAI, Nagoya (JP)

(21) Appl. No.: 18/937,769

(22) Filed: Nov. 5, 2024

Related U.S. Application Data
(63) Continuation of application No. PCT/JP2023/017388, filed on May 9, 2023.

(30) Foreign Application Priority Data
May 16, 2022 (JP) 2022-080384

(51) Int. Cl. G06V 10/98; G06V 10/72; G06V 10/75; G06V 10/77; G06V 10/774; G06V 10/82

(52) U.S. Cl. CPC G06V 10/993; G06V 10/72; G06V 10/759; G06V 10/7715; G06V 10/774; G06V 10/82

(57) ABSTRACT

A set of program instructions causes a computer to perform acquiring target image data indicating a target image including an object of an inspection target, inputting the target image data into an image generation model to generate first reproduction image data, generating first difference image data indicating a difference between the target image and a first reproduction image by using the target image data and the first reproduction image data, inputting the first difference image data into a feature extraction model to generate first feature data indicating a feature of the first difference image data, the feature extraction model being a machine learning model including an encoder configured to extract a feature of image data that is input, and detecting a difference between the object of the inspection target and an object of a comparison target by using the first feature data.

### REFERENCE TO RELATED APPLICATIONS

This is a Continuation Application of International Application No. PCT/JP2023/017388 filed on May 9, 2023, which claims priority from Japanese Patent Application No. 2022-080384 filed on May 16, 2022. The entire content of each of the prior applications is incorporated herein by reference.

### BACKGROUND ART

An anomaly detection using an image generation model which is a machine learning model for generating image data is known.

### SUMMARY

In a technique of anomaly detection, a plurality of captured image data acquired by capturing a normal item is input into a trained CNN (Convolutional Neural Network), and a plurality of feature maps are generated for each of the plurality of captured image data. And, a matrix of the Gaussian parameter which shows the feature of a normal item based on a particular number of feature maps that are randomly chosen from the plurality of feature maps is generated. At the time of inspection, a captured image acquired by capturing an item of the inspection target is input into CNN, a feature map is generated, and a feature vector which shows the feature of the item of the inspection target is generated based on the feature map. Anomaly detection of the item is performed using the matrix of a normal item and the feature vector of the item of the inspection target.

In this way, a technique of detecting a difference between an object of an inspection target and an object of a comparison target (for example, a difference between an item of an inspection target and a normal item) using a machine learning model has been required.

In view of the foregoing, an example of an object of this disclosure is to provide a technique of detecting a difference between an object of an inspection target and an object of a comparison target using a machine learning model.

According to one aspect, this specification discloses a non-transitory computer-readable storage medium storing a set of program instructions for a computer. The set of program instructions, when executed by the computer, causes the computer to acquire target image data indicating a target image including an object of an inspection target. The target image data is generated by using an image sensor. Thus, the target image data indicating the target image is acquired. The set of program instructions, when executed by the computer, causes the computer to input the target image data into an image generation model to generate first reproduction image data, the first reproduction image data indicating a first reproduction image corresponding to the target image. The image generation model is a machine learning model including an encoder configured to extract a feature of image data that is input and a decoder configured to generate image data based on the extracted feature. Thus, the image generation model generates the first reproduction image data from the target image data. The set of program instructions, when executed by the computer, causes the computer to generate first difference image data indicating a difference between the target image and the first reproduction image by using the target image data and the first reproduction image data. Thus, the first difference image data is generated. The set of program instructions, when executed by the computer, causes the computer to input the first difference image data into a feature extraction model and generate first feature data indicating a feature of the first difference image data. The feature extraction model is a machine learning model including an encoder configured to extract a feature of image data that is input. Thus, the feature extraction model generates the first feature data from the first difference image data. The set of program instructions, when executed by the computer, causes the computer to detect a difference between the object of the inspection target and an object of a comparison target by using the first feature data. Thus, the difference between the objects is detected.

According to the above-described configuration, the difference between the object of the inspection target and the object of the comparison target is detected using the first feature data. The first feature data is generated by inputting, into a feature extraction model, the first difference image data indicating the difference of the target image and the first reproduction image. As a result, the difference between the object of the inspection target and the object of the comparison target is detected using a machine learning model. For example, in a case where the target image contains a noise, or in a case where the difference between the object of the inspection target and the object of the comparison target is small, the difference between the object of the inspection target and the object of the comparison target is detected accurately.

According to another aspect, the object detection model is trained using the training image data which indicates the training image acquired by combining the object image with the background image and the region information which indicates the region where the object in the training image is located. The region information is information generated based on the position information which indicates the combining position of the object image used when the object image is combined with the background image. As a result, the label information indicates the region where an object is located accurately as compared with the case of using information which indicates the region specified by an operator, for example. Thus, the object detection model AN is trained such that the region where an object is located is detected accurately. For this reason, the difference between an object of the inspection target and the object of the comparison target is detected accurately.

According to another aspect, identifying the object region is performed using the object detection model which is common to both the object of the first type and the object of the second type. And, detection of the difference between the object of the inspection target and the object of the comparison target is performed using different machine learning models for the object of the first type and the object of the second type. As a result, the difference between the object of the inspection target and the object of the comparison target is detected with sufficient accuracy, while suppressing an excessive increase of the burden of training the object detection model and the machine learning model and an excessive increase of the data volume of the object detection model and the machine learning model.

According to another aspect, the burden for preparing image data for training is reduced.

The techniques disclosed in this specification may be realized with other various modes, and, for example, may be realized in the modes of an object detection model, a training apparatus of an object detection model, a training method, an inspection apparatus, an inspection method, a computer program for realizing the apparatus and method, a non-transitory computer-readable storage medium that stores such computer program, and so on.

### BRIEF DESCRIPTION OF DRAWINGS

FIG. 1 is a block diagram showing a configuration of an inspection system 1000.

FIG. 2A is a perspective view of a product 300.

FIG. 2B is an explanatory diagram of labels.

FIG. 3 is a flowchart of an inspection preparation process.

FIG. 4 is a flowchart of a training data generation flow.

FIGS. 5A, 5B, 5C, 5D, 5E, 5F, 5G and 5H are diagrams showing examples of images.

FIG. 6 is a flowchart of a normal image data generation process.

FIG. 7 is a flowchart of an abnormal image data generation process.

FIG. 8 is a flowchart of a composite image data generation process.

FIGS. 9A and 9B are explanatory diagrams of the composite image data generation process.

FIG. 10 is a flowchart of a training data generation process.

FIG. 11A is an explanatory diagram of an object detection model AN.

FIG. 11B is a flowchart of a training process of the object detection model AN.

FIG. 12A is an explanatory diagram of an image generation model GN.

FIG. 12B is a flowchart of a training process of the image generation model GN.

FIG. 13 is a flowchart of a training difference image data generation process.

FIG. 14A is an explanatory diagram of an image discrimination model DN.

FIG. 14B is a flowchart of a training process of the image discrimination model DN.

FIG. 15 is a flowchart of a PaDiM data generation process.

FIGS. 16A, 16B, 16C, 16D and 16E are first explanatory diagrams of the PaDiM data generation process.

FIGS. 17A, 17B, 17C and 17D are second explanatory diagrams of the PaDiM data generation process.

FIG. 18 is a flowchart of an inspection process.

FIGS. 19A, 19B, 19C, 19D and 19E are explanatory diagrams of the inspection process.

### DESCRIPTION

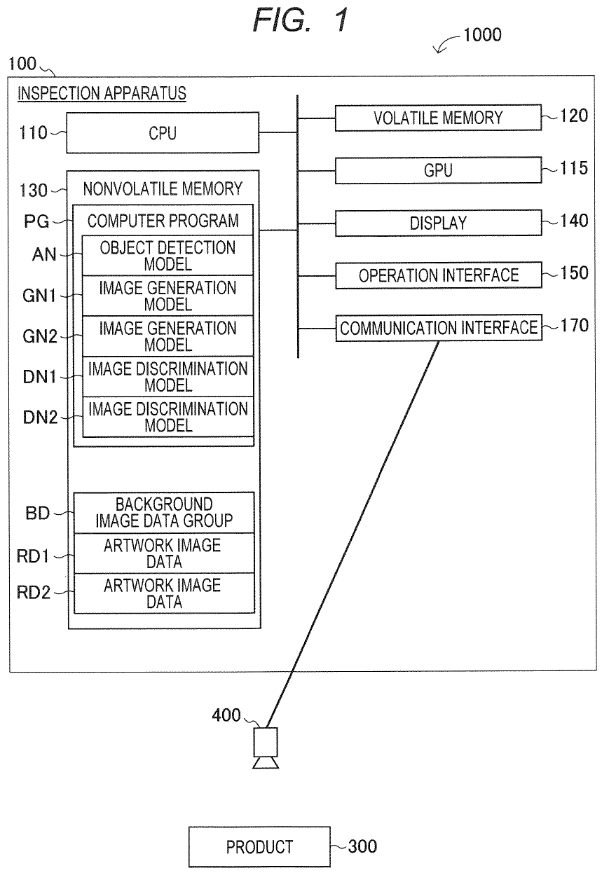

An inspection apparatus according to an embodiment will be described. FIG. 1 is a block diagram showing a configuration of an inspection system 1000 of an embodiment. The inspection system 1000 includes an inspection apparatus 100 and an image capturing device (camera) 400. The inspection apparatus 100 and the image capturing device 400 are connected so as to communicate with each other.

The inspection apparatus 100 is a computer, such as a personal computer, for example. The inspection apparatus 100 includes a CPU 110 as a controller of the inspection apparatus 100, a GPU 115, a volatile memory 120 such as a RAM, a nonvolatile memory 130 such as a hard disk drive, an operation interface 150 such as a mouse and a keyboard, a display 140 such as a liquid crystal display, and a communication interface 170. The communication interface 170 includes a wired or wireless interface for communicating with an external device such as the image capturing device 400.

The GPU (Graphics Processing Unit) 115 is a processor that performs computation for image processing such as three-dimensional (3D) graphics, according to control of the CPU 110. In this embodiment, the GPU 115 is used in order to perform computation processing of machine learning models.

The volatile memory 120 provides a buffer area for temporarily storing various intermediate data generated when the CPU 110 performs processing. The nonvolatile memory 130 stores a computer program PG for the inspection apparatus, background image data group BD, and artwork image data RD1 and RD2. The background image data group BD and the artwork image data RD1 and RD2 will be described later.

The computer program PG includes, as a module, a computer program by which the CPU 110 and the GPU 115 cooperate and realizes the functions of a plurality of machine learning models. The computer program PG is provided by the manufacturer of the inspection apparatus 100, for example. The computer program PG may be provided with a form downloaded from a server, for example, or may be provided with a form stored in a DVD-ROM and so on. The CPU 110 performs an inspection preparation process and an inspection process described below by executing the computer program PG.

The plurality of machine learning models include an object detection model AN, image generation models GN1 and GN2, and image discrimination models DN1 and DN2. The configurations and the use methods of these models are described below.

The image capturing device 400 is a digital camera that generates image data (also referred to as captured image data) indicating an image capturing target by capturing the image capturing target by using a two-dimensional image sensor. The captured image data is bitmap data indicating an image including a plurality of pixels, and, specifically, is RGB image data indicating the color for each pixel with RGB values. The RGB values are color values of the RGB color coordinates including gradation values of three color components (hereinafter referred to as component values), that is, R value, G value, and B value. The R value, G value, and B value are gradation values of a particular gradation number (for example, 256), for example. The captured image data may be luminance image data indicating the luminance for each pixel.

The image capturing device 400 generates captured image data and transmits the captured image data to the inspection apparatus 100 in accordance with control of the inspection apparatus 100. In this embodiment, the image capturing device 400 is used to capture the product 300 on which a label L which is an inspection target of the inspection process is affixed and to generate captured image data indicating a captured image.

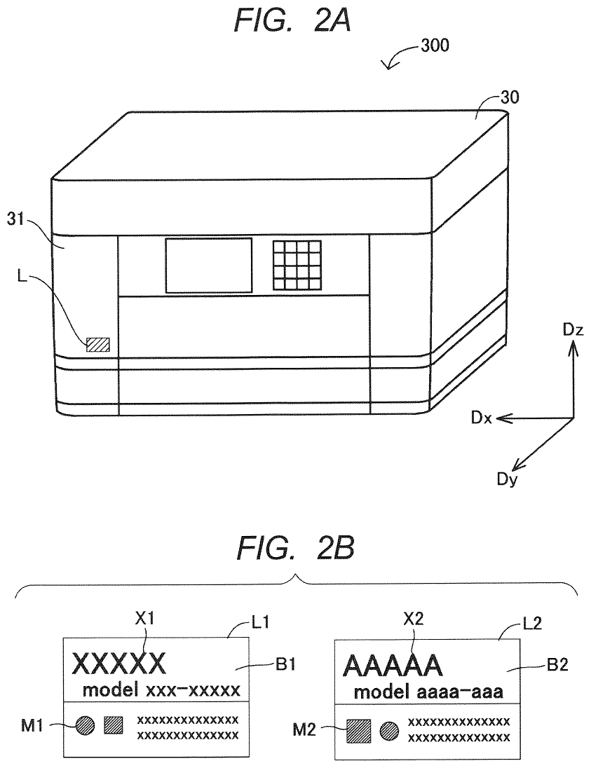

FIG. 2A shows a perspective view of the product 300. The product 300 is a printer including a housing 30 of a substantially rectangular parallelepiped shape in the present embodiment. In a manufacturing process, the rectangular label L is affixed to a front surface 31 (the surface on +Dy side) of the housing 30 at a particular affix position.

FIG. 2B shows two types of labels L1 and L2 as an example of the label L. The label L1 includes a background B1, characters X1 indicating various kinds of information such as a brand logo of a manufacturer or a product, a product number, and a lot number, and a mark M1, for example. Similarly, the label L2 includes a background B2, characters X2, and a mark M2, for example. The two types of labels L1 and L2 are affixed to different products, for example, and at least part of the characters or the mark differ from each other. In present embodiment, two types of labels L1 and L2 serve as an inspection target.

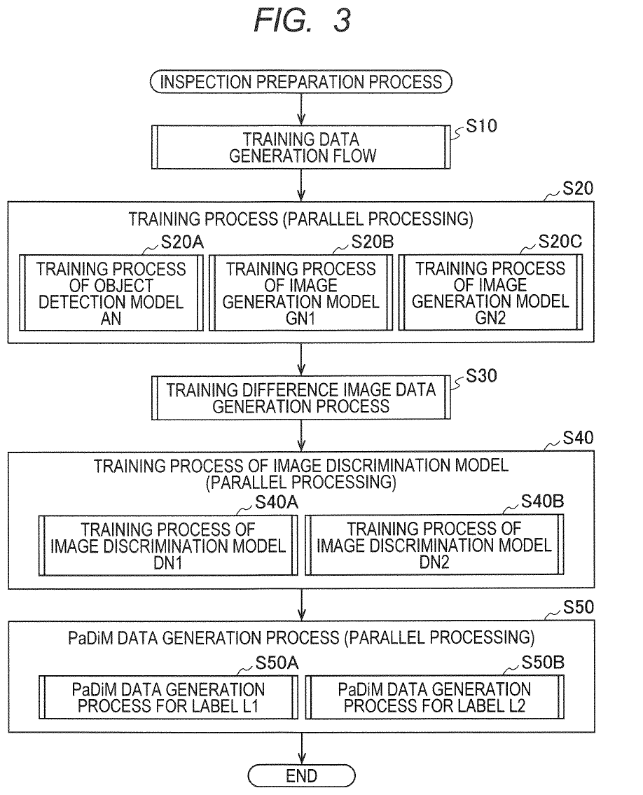

The inspection preparation process is performed before the inspection process (described later) for inspecting the label L. The inspection preparation process includes training of the machine learning models (the object detection model AN, the image generation models GN1, GN2, and the image discrimination models DN1, DN2) used by the inspection process, and generation of the Gaussian matrix GM (described later) indicating the feature of a normal label L (hereinafter referred to as a normal item). FIG. 3 is a flowchart of the inspection preparation process.

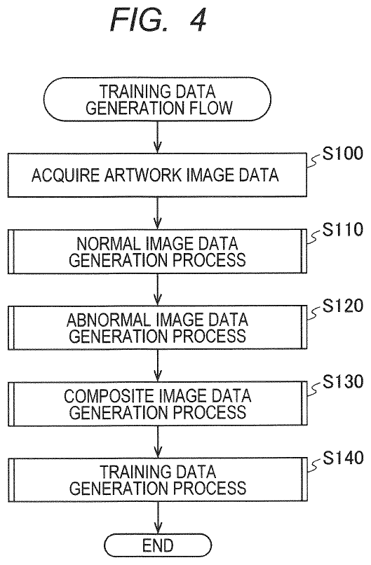

In S10, the CPU 110 performs a training data generation flow. The training data generation flow is a flow of processes for generating image data and training data used for training of the machine learning model by using the artwork image data RD1 and RD2. FIG. 4 is a flowchart of the training data generation flow.

In S100, the CPU 110 acquires the artwork image data RD1 and RD2 indicating an artwork image, from the nonvolatile memory 130. The artwork image data RD1 and RD2 are bit map data similar to captured image data, and are RGB image data in the present embodiment. The artwork image data RD1 is data used for producing the label L1, and the artwork image data RD2 is data used for producing the label L2. That is, the artwork image data RD1 and RD2 are design data used for producing the labels L1 and L2, respectively. For example, the label L1 is produced by printing, on a sheet for a label, an artwork image DI1 (described later) indicated by the artwork image data RD1. The training data generation flow performed using the artwork image data RD1 will be described below, but the training data generation flow is performed similarly when the artwork image data RD2 is used.

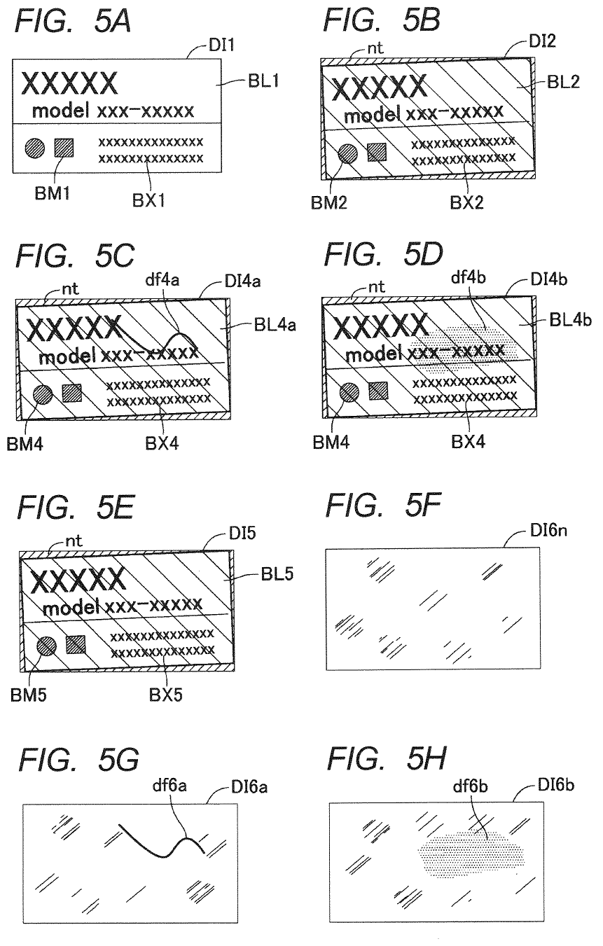

The artwork image DI1 of FIG. 5A shows a label BL1. In this way, the reference sign “BL1” is used in order to distinguish the label shown in the artwork image DI1 from the actual label L1. The label BL1 is a CG (computer graphics) image indicating the actual label L, and includes characters BX1 and a mark BM1.

The CG image is an image generated by a computer. For example, the CG image is generated by rendering (also referred to as rasterizing) of vector data including a drawing command for drawing an object.

In the present embodiment, the artwork image DI1 includes the label BL1, and does not include background. In the artwork image DI1, the label BL1 is not inclined. That is, the four sides of the rectangular of the artwork image DI1 and the four sides of the rectangular of the label BL1 match.

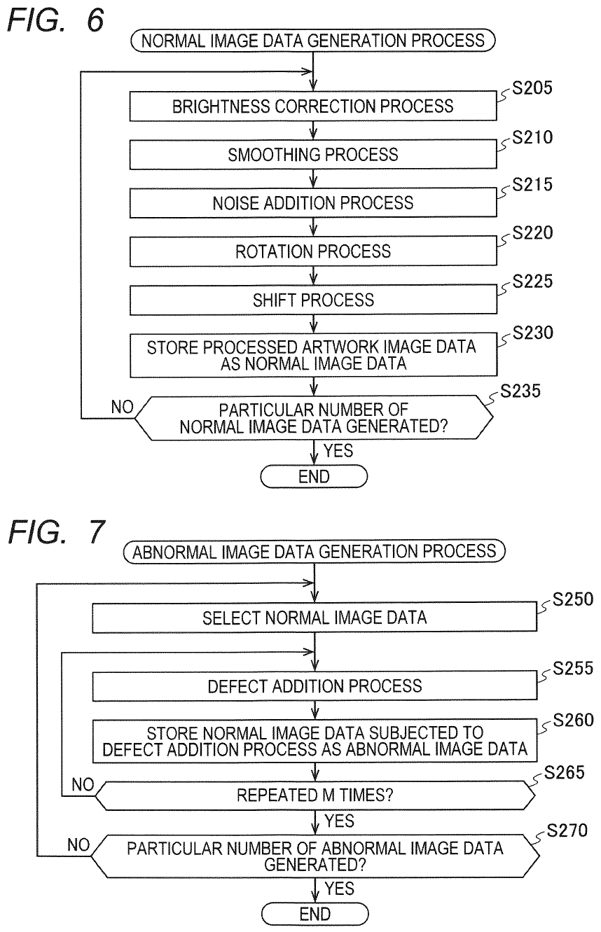

In S110, the CPU 110 performs a normal image data generation process. The normal image data generation process is a process of generating normal image data indicating an image of a normal item that does not include a defect (also hereinafter referred to as a normal image) by using the artwork image data RD1. FIG. 6 is a flowchart of the normal image data generation process.

In S205, the CPU 110 performs a brightness correction process to the artwork image data RD1. The brightness correction process is a process which changes the brightness of an image. For example, the brightness correction process is performed by converting each of three component values (R value, G value, B value) of the RGB value of each pixel by using a gamma curve. The gamma value of the gamma curve is determined at random within a range of 0.7 to 1.3, for example. The gamma value is a parameter that determines the degree of brightness correction. In a case where the gamma value is less than 1, the R value, G value, and B value increase by correction, and thus the brightness becomes higher. In a case where the gamma value is greater than 1, the R value, G value, and B value decrease by correction, and thus the brightness becomes lower.

In S210, the CPU 110 performs a smoothing process to the artwork image data RD1 to which the brightness correction process has been performed. The smoothing process is a process of smoothing an image. Due to the smoothing process, edges in an image blur. As the smoothing process, a smoothing process using a Gaussian filter is used, for example. For example, the standard deviation sigma (a) which is a parameter of the Gaussian filter is determined at random within a range of 0 to 3. Due to this, variations are given to the degree of blurring of edges. In a modification, a smoothing process that uses a Laplacian filter or a median filter may be used.

In S215, the CPU 110 performs a noise addition process on the artwork image data RD1 on which the smoothing process has been performed. The noise addition process is a process for adding noise to an image. For example, the noise is in accordance with a normal distribution, and is, for example, noise based on a normal distribution random number generated by parameters of an average of 0 and a variance of 10 for all pixels.

In S220, the CPU 110 performs a rotation process on the artwork image data RD1 on which the noise addition process has been performed. The rotation process is a process for rotating an image by a particular rotation angle. The particular rotation angle is determined at random within a range of −3 degrees to +3 degrees, for example. For example, a positive rotation angle indicates a clockwise rotation and a negative rotation angle indicates a counterclockwise rotation. The rotation is performed, for example, about the center of gravity of the artwork image DI1.

In S225, the CPU 110 performs a shift process on the artwork image data RD1 after the rotation process has been performed. The shift process is a process for shifting the label portion in the image by a shift amount. The shift amount in the vertical direction is determined at random, for example, within a range of several percents of the number of pixels in the vertical direction of the artwork image DI1, and in the present embodiment, within a range of −20 to +20 pixels. Similarly, the shift amount in the horizontal direction is determined at random within a range of several percents of the number of pixels in the horizontal direction, for example.

In S230, the CPU 110 stores, as normal image data, the processed artwork image data RD1 after the processing in S205 to S230 is performed. For example, the processed artwork image data RD1 is stored in the nonvolatile memory 130 in association with identification information indicating a normal image. FIG. 5B shows a normal image DI2 indicated by the normal image data. The label BL2 of the normal image DI2 is different from the label BL1 of the artwork image DI1 (FIG. 5A) in the overall brightness, the inclination, the position of the center of gravity, and the degree of blur of a mark BM2 and characters BX2, for example. Due to the rotation process and the shift process described above, gaps nt are generated between the four sides of the normal image DI2 and the four sides of the label BL2. The region of the gaps nt is filled with pixels of a particular color, for example, white.

In S235, the CPU 110 determines whether a particular number (for example, several hundreds to several thousands) of normal image data have been generated. In a case where the particular number of normal image data have not been generated (S235: NO), the CPU 110 returns the processing to S205. In a case where the particular number of normal image data have been generated (S235: YES), the CPU 110 ends the normal image data generation process.

The image processing (the shift process, the rotation process, the noise addition process, the brightness correction process, and the smoothing process) included in the normal image data generation process is an example, and may be appropriately omitted, and other image processing may be appropriately added. For example, a process of appropriately replacing or modifying the color or shape of some of the components (for example, characters or marks) in the artwork image DI1 may be added.

In S120 of FIG. 4 after the normal image data generation process, the CPU 110 performs an abnormal image data generation process using the generated normal image data. The abnormal image data generation process is a process for generating abnormal image data indicating an image of an abnormal item including a defect (hereinafter, also referred to as an abnormal image). FIG. 7 is a flowchart of the abnormal image data generation process.

In S250, the CPU 110 selects one normal image data to be processed, from among the plurality of normal image data generated in the normal image data generation process in S110 in FIG. 4. This selection is performed at random, for example.

In S255, the CPU 110 performs a defect addition process on the normal image data to be processed. The defect addition process is a process of adding a defect such as a scratch or stain to the normal image DI2 in a pseudo manner.

The abnormal image indicated by the abnormal image data is an image indicating a label including a pseudo defect. For example, a label BL4a of an abnormal image DI4a in FIG. 5C includes an image that indicates a linear scratch as a pseudo defect (hereinafter, also referred to as a linear scratch df4a), in addition to characters BX4 and a mark BM4. The linear scratch df4a is, for example, a curve such as a Bezier curve or a spline curve. For example, the CPU 110 generates the linear scratch df4a by randomly determining the position and number of control points, the thickness of the line, and the color of the line of a Bezier curve, within a particular range. The CPU 110 combines the generated linear scratch df4a with the normal image DI2. In this way, the abnormal image data indicating the abnormal image DI4a is generated. In the present embodiment, in addition to the linear scratch, abnormal image data in which a pseudo stain and a circular scratch are combined are also generated. For example, a label BL4b of an abnormal image DI4b in FIG. 5D includes an image that indicates a stain as a pseudo defect (hereinafter, also referred to as a stain df4b), in addition to characters BX4 and a mark BM4. The stain df4b is generated by, for example, arranging a large number of minute points in a particular region. In a modification, the pseudo defect may be generated by capturing an image of a defect and extracting the defect portion from the image acquired by capturing the defect. In a modification, the pseudo defect may include other types of defects such as a missing or crushed character or mark, or a folded corner of a label, for example.

In S260, the CPU 110 stores, as abnormal image data, the normal image data on which the defect addition process has been performed. For example, the normal image data subjected to the defect addition process is stored in the nonvolatile memory 130 in association with identification information indicating the type of the added defect (in the present embodiment, any one of three types of linear scratch, stain, and circular scratch).

In S265, the CPU 110 determines whether the processing of S255 and S260 has been repeated M times (M is an integer of 2 or more). In other words, it is determined whether M abnormal image data different from each other have been generated based on one normal image data. In a case where the processing of S255 and S260 has not been repeated M times (S265: NO), the CPU 110 returns the processing to S255. In a case where the processing of SS255 and S260 has been repeated M times (S265: YES), the CPU 110 advances the processing to S270. For example, the integer M is in the range of 2 to 5.

In S270, the CPU 110 determines whether a particular number of abnormal image data have been generated. In the present embodiment, the CPU 110 determines that the particular number of abnormal image data have been generated in a case where several hundreds to several thousands of abnormal image data to which three types of defects, that is, linear scratch, stain, and circular scratch, are added have been generated. More specifically, the CPU 110 determines that the particular number of abnormal image data have been generated in a case where several hundreds to several thousands of abnormal image data to which a linear scratch is added have been generated, several hundreds to several thousands of abnormal image data to which a stain is added have been generated, and several hundreds to several thousands of abnormal image data to which a circular scratch is added have been generated. In a case where the particular number of abnormal image data have not been generated (S270: NO), the CPU 110 returns the processing to S250. In a case where the particular number of abnormal image data have been generated (S270: YES), the CPU 110 ends the abnormal image data generation process.

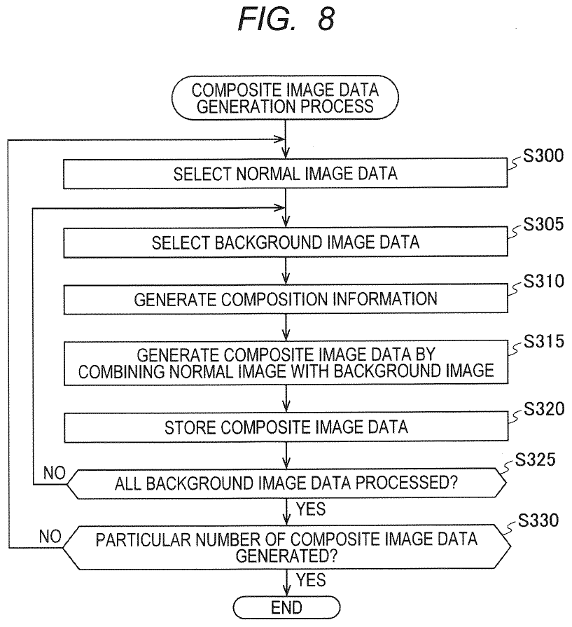

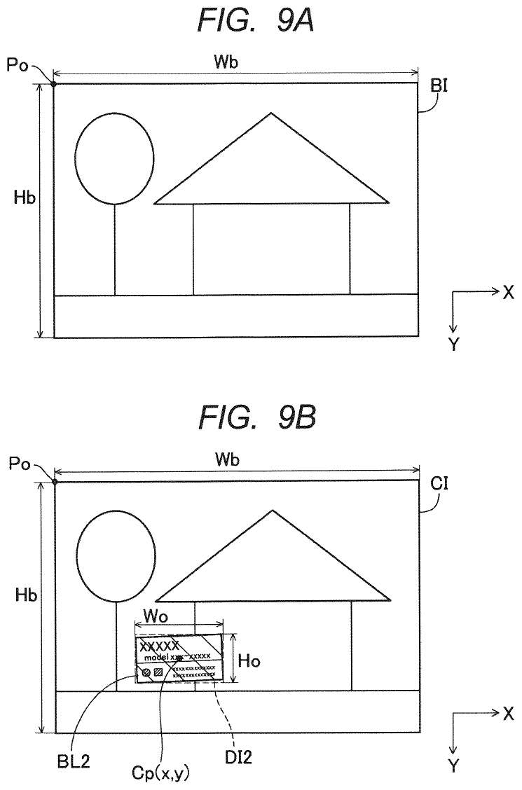

In S130 of FIG. 4 after the abnormal image data generation process, the CPU 110 performs a composite image data generation process by using the generated normal image data and the background image data. The composite image data generation process is a process of generating composite image data indicating a composite image acquired by combining the label image (the normal image DI2 in the present embodiment) with the background image. FIG. 8 is a flowchart of the composite image data generation process. FIGS. 9A and 9B are explanatory diagrams of the composite image data generation process.

In S300, the CPU 110 selects one normal image data to be processed, from among the plurality of normal image data generated in the normal image data generation process in S110 in FIG. 4. This selection is performed at random, for example.

In S305, the CPU 110 selects one background image data to be processed, from among the background image group BD. FIG. 9A shows an example of a background image BI indicated by the background image data. Each background image data included in the background image data group BD is captured image data acquired by capturing various subjects (for example, a landscape, a room, and a device such as a printer) by using, for example, a digital camera. The background image data is not limited to this, and may include, for example, scan data acquired by reading a document such as a picture or a photograph using a scanner. The number of background image data included in the background image data group BD is, for example, several tens to several thousands. The size of the background image BI (the number of pixels in the X direction and the Y direction in FIGS. 9A and 9B) is adjusted to the size of an input image of an object detection model AN described later.

In S310, the CPU 110 generates composition information for combining the normal image DI2 with the background image BI. For example, the composition information includes position information indicating a composition position at which the normal image DI2 is arranged and an enlargement ratio at the time of composition. The enlargement ratio is a value indicating the degree of enlargement or reduction of the normal image DI2, and is randomly determined within a particular range (for example, 0.7 to 1.3). The position information indicates, for example, coordinates (x, y) at which a center of gravity Cp of the normal image DI2 should be located at the time of composition in a coordinate system in which an upper left vertex Po of the background image BI is the origin. The coordinates (x, y) at which the center of gravity Cp of the normal image DI2 should be located are determined at random within a range in which the entire normal image DI2 is located within the background image BI, for example. The composition information is also used in a training data generation process described below.

In S315, the CPU 110 generates composite image data indicating the composite image Cl using the selected background image data and the selected normal image data. More specifically, the CPU 110 performs a size adjustment process on the normal image data, the size adjustment process being a process of enlarging or reducing the normal image DI2 in accordance with the enlargement ratio included in the composition information. The CPU 110 performs a combining process of combining the normal image DI2 subjected to the size adjustment process with the background image BI. In the combining process, the CPU 110 generates an alpha channel, which is information defining a transparency α (alpha), for each of the plurality of pixels of the normal image DI2. The transparency α of the pixels constituting the label BL2 of the normal image DI2 (FIG. 5B) is set to 1 (0%), and the transparency α of the pixels constituting the gaps nt is set to 0 (100%). The CPU 110 identifies pixels on the background image BI that overlap pixels (pixels for which the transparency α is set to 1) that constitute the label BL2 of the normal image DI2 in a case where the normal image DI2 is arranged on the background image BI in accordance with the position information included in the composition information. The CPU 110 replaces the values of the plurality of identified pixels of the background image BI with the values of the plurality of corresponding pixels of the normal image DI2. As a result, composite image data indicating a composite image Cl (FIG. 9B) is generated in which the background image BI and the normal image DI2 are combined where the background image BI is the background and the normal image DI2 is the foreground.

In S320, the CPU 110 stores the generated composite image data in the nonvolatile memory 130. For example, the CPU 110 stores the composite image data in the nonvolatile memory 130 in association with identification information indicating the type of the label BL2 (for example, either the label L1 or L2) indicated by the normal image DI2 used for generating the composite image data.

In S325, the CPU 110 determines whether all background image data have been processed. In a case where there is an unprocessed background image data (S325: NO), the CPU 110 returns the processing to S305. In a case where all the background image data have been processed (S325: YES), the CPU 110 advances the processing to S330.

In S330, the CPU 110 determines whether a particular number (for example, several thousands to several tens of thousands) of composite image data have been generated. In a case where the particular number of composite image data have not been generated (S330: NO), the CPU 110 returns the processing to S300. In a case where the particular number of composite image data have been generated (S330: YES), the CPU 110 ends the composite image data generation process.

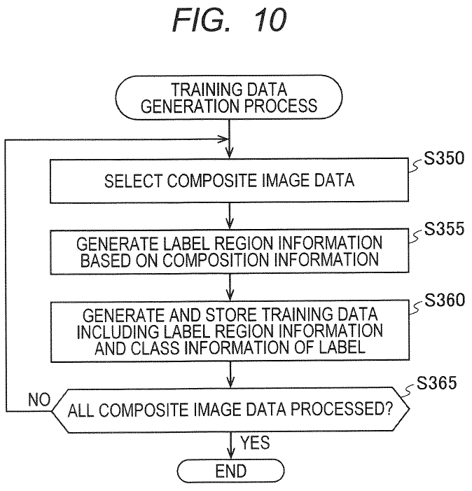

In S140 of FIG. 4 after the composite image data generation process, the CPU 110 performs a training data generation process. The training data generation process is a process for generating training data used in a training process of the object detection model AN described later. FIG. 10 is a flowchart of the training data generation process.

In S350, the CPU 110 selects one composite image data to be processed, from among the plurality of composite image data generated in the composite image data generation process in S130 in FIG. 4.

In S355, the CPU 110 generates label region information indicating a region in which the label BL2 is arranged in the composite image Cl, based on the composite information generated when the composite image data to be processed is generated. Specifically, the CPU 110 generates the label region information including a width Wo (size in the X direction) and a height Ho (size in the Y direction) of the region in which the normal image DI2 is arranged in the composite image Cl and coordinates Cp (x, y) of the center of gravity Cp of the region in which the normal image DI2 is arranged in the composite image Cl. The width Wo and the height Ho of the region are calculated using the width and the height of the normal image DI2 before the composition and the enlargement ratio included in the composition information. The coordinates Cp (x, y) are determined in accordance with the position information included in the composition information.

In S360, the CPU 110 generates and stores training data including the label region information generated in S350 and class information indicating the type of label (also referred to as a class). The class information indicates the type of the label BL2 (in the present embodiment, either the label L1 or L2) indicated in the normal image DI2 used for generating the composite image data to be processed. The training data is stored in the nonvolatile memory 130 in association with the composite image data to be processed. The training data corresponds to the output data OD of the object detection model AN. Thus, when the object detection model AN is described later, the training data will be supplementarily described.

In S365, the CPU 110 determines whether all the composite image data have been processed. In a case where there is an unprocessed composite image data (S365: NO), the CPU 110 returns the processing to S350. If all the composite image data have been processed (S365: YES), the CPU 110 ends the training data generation process. When the training data generation process ends, the training data generation flow of FIG. 4 ends.

In S20 of FIG. 3 after the training data generation flow, the CPU 110 performs a training process of the object detection model AN of S20A, a training process of the image generation model GN1 of S20B, and a training process of the image generation model GN2 of S20C in parallel. By performing these training processes in parallel, the overall processing time of the inspection preparation process is reduced. The outline of these machine learning models and the training processes will be described below.

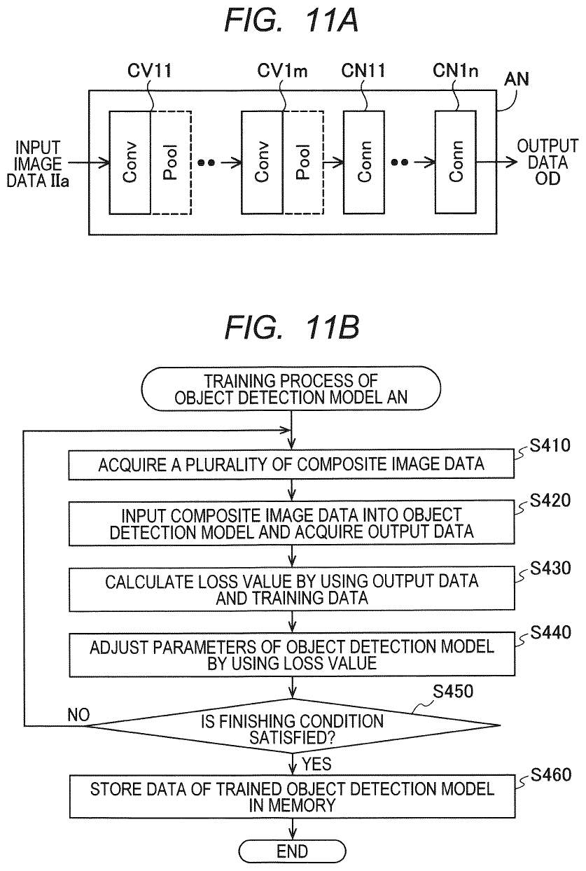

FIG. 11A is a schematic diagram showing an example of a configuration of the object detection model AN. Various object detection models may be adopted as the object detection model AN. In the present embodiment, the object detection model AN is an object detection model called YOLO (You only look once). The YOLO is disclosed, for example, in the article “Joseph Redmon, Santosh Divvala, Ross Girshick, Ali Farhadi, “You Only Look Once: Unified, Real-Time Object Detection”, Proceedings of the IEEE Conference on Computer Vision and Pattern Recognition (CVPR), 2016, pp. 779-788”. The YOLO model predicts a region where an object in an image is located and a type of the object located in the region by using a convolutional neural network.

As shown in FIG. 11A, the object detection model AN includes m (m is an integer of 1 or more) convolution layers CV11 to CV1m and n (n is an integer of 1 or more) fully connected layers CN11 to CNln following the convolution layers CV11 to CV1m. Here, m is 24, for example, and n is 2, for example. A pooling layer is provided immediately after one or more convolution layers of the m convolution layers CV11 to CV1m.

The convolution layers CV11 to CV1m perform processing including a convolution process and a bias addition process on data that is input. The convolution process is a process of sequentially applying t filters to input data and calculating a correlation value indicating a correlation between the input data and the filters (t is an integer of 1 or more). In the process of applying the filter, a plurality of correlation values are sequentially calculated while sliding the filter. The bias addition process is a process of adding a bias to the calculated correlation value. One bias is prepared for each filter. The dimension of the filters and the number of filters t are usually different among the m convolution layers CV11 to CV1m. Each of the convolution layers CV11 to CV1m has a parameter set including a plurality of weights and a plurality of biases of a plurality of filters.

The pooling layer performs a process of reducing the number of dimensions of data on the data input from the convolution layer immediately before. As the pooling process, various processes such as average pooling and maximum pooling may be used. In the present embodiment, the pooling layer performs maximum pooling. The maximum pooling reduces the number of dimensions by sliding a window of a particular size (for example, 2×2) by a particular stride (for example, 2) and selecting the maximum value in the window.

The fully connected layers CN11 to CNln use f dimensional data (that is, f values) that are input from the previous layer to output g dimensional data (that is, g values). Here, f is an integer of 2 or more, and G is an integer of 2 or more. Each of the g output values is a value acquired by adding a bias to the inner product of a vector formed by the f input values and a vector formed by the f weights. The number of dimensions f of the input data and the number of dimensions g of the output data are usually different among the n fully-connected layers CN11 to CN1n. Each of the fully connected layers CN11 to CN1n has a parameter set including a plurality of weights and a plurality of biases.

The data generated by each of the convolution layers CV11 to CV1m and the fully connected layers CN11 to CN1n is input to an activation function and converted. Various functions may be used as the activation function. In the present embodiment, a linear activation function is used for the last layer (here, the fully connected layer CN1n), and a leaky rectified linear unit (LReLU) is used for the other layers.

An outline of the operation of the object detection model AN will be described. Input image data IIa is input to the object detection model AN. In the present embodiment, in the training process, composite image data indicating the composite image CI (FIG. 9B) is input as the input image data IIa.

When the input image data IIa is input, the object detection model AN performs arithmetic processing using the above-described parameter set on the input image data IIa to generate the output data OD. The output data OD is data including S×S×(Bn×5+C) prediction values. Each prediction value includes prediction region information indicating a prediction region (also referred to as a bounding box) in which an object (a label in the present embodiment) is predicted to be located, and class information indicating a type (also referred to as a class) of an object existing in the prediction region.

Bn pieces of prediction region information are set for each of S×S cells acquired by dividing an input image (for example, the composite image CI) into S×S images. Here, Bn is an integer of 1 or more, for example, 2. S is an integer of 2 or more, for example, 7. Each prediction region information includes five values of center coordinates (Xp, Yp), a width Wp, a height Hp of the prediction region with respect to the cell, and a confidence Vc. The confidence Vc is information indicating a probability that an object exists in the prediction region. The class information is information indicating the type of an object existing in a cell by the probability of each type. The class information includes values indicating C probabilities in a case where the types of the objects are classified into C types. Here, C is an integer of 1 or more, and is 2 in the present embodiment. Thus, the output data OD includes S×S×(Bn×5+C) prediction values as described above.

The training data generated in S360 of FIG. 10 corresponds to the output data OD. Specifically, the training data indicates ideal output data OD to be output when corresponding composite image data is input to the object detection model AN. That is, as an ideal prediction value corresponding to a cell in which the center of the label BL2 (normal image DI2) is located in the composite image C1 (FIG. 9B) among the S×S×(Bn×5+C) prediction values, the training data includes the label region information, the maximum confidence Vc (for example, 1), and the class information indicating the type of the label. Further, the training data includes a minimum confidence Vc (for example, 0) as a prediction value corresponding to a cell in which the center of the label BL2 is not located.

Next, a training process (S20A in FIG. 3) of the object detection model AN will be described. FIG. 11B is a flowchart of the training process of the object detection model AN. The object detection model AN is trained such that the output data OD indicates an appropriate label region of the input image (for example, the composite image CI) and an appropriate label type. By training, a plurality of parameters used for the operation of the object detection model AN (including a plurality of parameters used for the operation of each of the plurality of layers CV11 to CV1m and CN11 to CN1n) are adjusted. Before the training process, the plurality of parameters are set to initial values such as random values.

In S410, the CPU 110 acquires a plurality of composite image data of a batch size from the nonvolatile memory 130. In S420, the CPU 110 inputs the plurality of composite image data to the object detection model AN, and generates a plurality of output data OD corresponding to the plurality of composite image data.

In S430, the CPU 110 calculates a loss value using the plurality of output data OD and a plurality of training data corresponding to the plurality of output data OD. Here, the training data corresponding to the output data OD means the training data stored in S360 of FIG. 10 in association with the composite image data corresponding to the output data OD. The loss value is calculated for each composite image data.

A loss function is used to calculate the loss value. The loss function may be various functions for calculating a loss value corresponding to a difference between the output data OD and the training data. In the present embodiment, the loss function disclosed in the above-mentioned YOLO paper is used. The loss function includes, for example, a region loss term, an object loss term, and a class loss term. The region loss term is a term that calculates a smaller loss value as the difference between the label region information included in the training data and the corresponding prediction region information included in the output data OD is smaller. The prediction region information corresponding to the label region information is prediction region information associated with the cell associated with the label region information among the plurality of prediction region information included in the output data OD. The object loss term is a term that calculates a smaller value as the difference between the value (0 or 1) of the training data and the value of the output data OD is smaller, regarding the confidence Vc of each prediction region information. The class loss term is a term that calculates a smaller loss value as the difference between class information included in the training data and corresponding class information included in the output data OD is smaller. The corresponding class information included in the output data OD is class information associated with the cell associated with the class information of the training data among the plurality of class information included in the output data OD. As a specific loss function of each term, a known loss function for calculating a loss value corresponding to a difference, for example, a square error, a cross entropy error, or an absolute error is used.

In S440, the CPU 110 adjusts a plurality of parameters of the object detection model AN by using the calculated loss value. Specifically, the CPU 110 adjusts the parameters in accordance with a particular algorithm such that the total of the loss values calculated for each of the composite image data becomes small. As the particular algorithm, for example, an algorithm using the error backpropagation method and the gradient descent method is used.

In S450, the CPU 110 determines whether a finishing condition of training is satisfied. The finishing condition may be various conditions. The finishing condition is, for example, that the loss value becomes less than or equal to a reference value, that the amount of change in the loss value becomes less than or equal to a reference value, or that the number of times the adjustment of the parameter of S440 is repeated becomes greater than or equal to a particular number.

In a case where the finishing condition of the training is not satisfied (S450: NO), the CPU 110 returns the processing to S410 and continues the training. In a case where the finishing condition of the training is satisfied (S450: YES), the CPU 110 stores the trained object detection model AN including the adjusted parameters in the nonvolatile memory 130 in S460, and ends the training process.

The output data OD generated by the trained object detection model AN has the following characteristics. In the output data OD, one of the prediction region information associated with the cell including the center of the label in the input image includes information appropriately indicating the region of the label in the input image and a high confidence Vc (the confidence Vc close to 1). In the output data OD, the class information associated with the cell including the center of the label in the input image appropriately indicates the type of the label. The other prediction region information included in the output data OD includes information indicating a region different from the region of the label and a low confidence Vc (the confidence Vc close to 0). Thus, the region of the label in the input image is identified by using the prediction region information including the high confidence Vc.

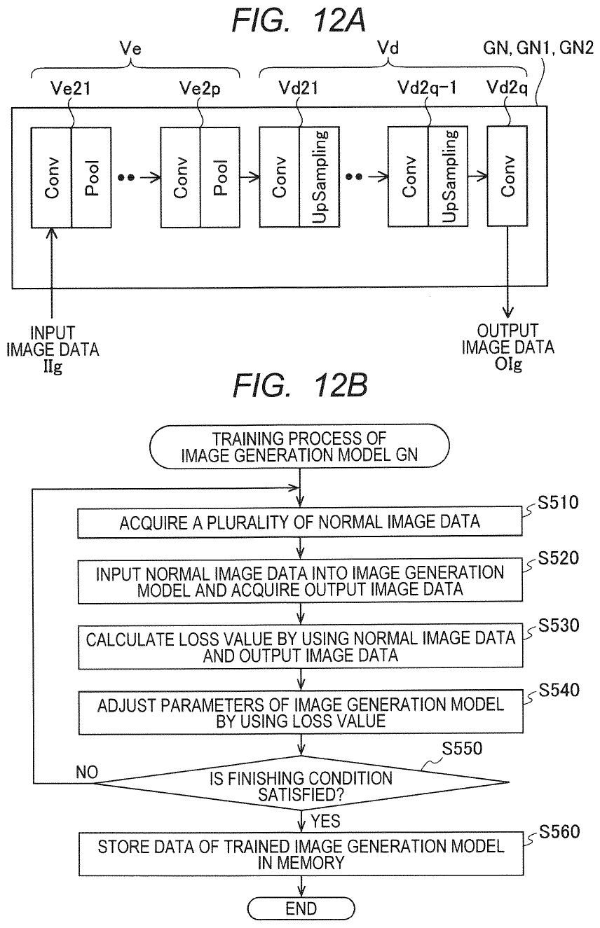

Next, the configuration of the image generation models GN1 and GN2 and the training process of the image generation models GN1 and GN2 (S20B and S20C in FIG. 3) will be described. The image generation models GN1 and GN2 have the same configuration, and thus will be described as the configuration of an image generation model GN. FIG. 12A is a schematic diagram showing an example of the configuration of the image generation model GN. In the present embodiment, the image generation model GN is a so-called autoencoder, and includes an encoder Ve and a decoder Vd.

The encoder Ve performs a dimension reduction process on input image data IIg indicating an image of an object and extracts a feature of the input image (for example, the normal image DI2 in FIG. 5B) indicated by the input image data IIg to generate feature data. In the present embodiment, the encoder Ve includes p convolution layers Ve21 to Ve2p (m is an integer of 1 or more). A pooling layer (for example, a max-pooling layer) is provided immediately after each convolution layer. The activation function of each of the p convolution layers is ReLU, for example.

The decoder Vd performs a dimension restoration process on the feature data to generate output image data OIg. The output image data OIg represents an image reconstructed based on the feature data. The image size of the output image data OIg and the color components of the color value of each pixel of the output image data OIg are the same as those of the input image data IIg.

In the present embodiment, the decoder Vd includes q (q is an integer of 1 or more) convolution layers Vd21 to Vd2q. An upsampling layer is provided immediately after each of the convolution layers except for the last convolution layer Vd2q. The activation function of the last convolution layer Vd2q is a function suitable for generating the output image data OIg (for example, a sigmoid function or a Tanh function). The activation function of each of the other convolution layers is ReLU, for example.

The convolution layers Ve21 to Ve2p and Vd21 to Vd2q perform processing including a convolution process and a bias addition process on the data that is input. Each of the convolution layers has a parameter set including a plurality of weights and a plurality of biases of a plurality of filters used for the convolution process.

Next, the training process (S20B and S20C in FIG. 3) of the image generation model GN will be described. FIG. 12B is a flowchart of the training process of the image generation model GN. A plurality of parameters used for the operation of the image generation model GN (including a plurality of parameters used for the operation of each of the convolution layers Ve21 to Ve2p and Vd21 to Vd2q) are adjusted by the training. Before the training process, the plurality of parameters are set to initial values such as random values.

In S510, the CPU 110 acquires a plurality of normal image data of a batch size from the nonvolatile memory 130. Here, since the image generation model GN1 is the image generation model GN for the label L1, the normal image data indicating the label L1 is acquired in the training process of the image generation model GN1. Since the image generation model GN2 is the image generation model GN for the label L2, the normal image data indicating the label L2 is acquired in the training process of the image generation model GN2. Thereby, the image generation model GN1 is trained for the label L1 and the image generation model GN2 is trained for the label L2. In S520, the CPU 110 inputs a plurality of normal image data to the image generation model GN, and generates a plurality of output image data OIg corresponding to the plurality of normal image data.

In S530, the CPU 110 calculates a loss value using the plurality of normal image data and the plurality of output image data OIg corresponding to the plurality of normal image data. Specifically, the CPU 110 calculates an evaluation value indicating a difference between the normal image data and the corresponding output image data OIg for each normal image data. The loss value is, for example, a total value of cross entropy errors of component values of each color component for each pixel. For the calculation of the loss value, another known loss function for calculating a loss value corresponding to the difference between the component values, for example, a square error or an absolute error may be used.

In S540, the CPU 110 adjusts the plurality of parameters of the image generation model GN by using the calculated loss value. Specifically, the CPU 110 adjusts the parameters according to a particular algorithm such that the total of the loss value calculated for each normal image data becomes small. As the particular algorithm, for example, an algorithm using the error backpropagation method and the gradient descent method is used.

In S550, the CPU 110 determines whether a finishing condition of training is satisfied. Similarly to S450 of FIG. 11B, various conditions are used as the finishing condition. The various conditions include that the loss value becomes less than or equal to a reference value, that the amount of change in the loss value becomes less than or equal to a reference value, and that the number of times the adjustment of the parameters of S540 is repeated becomes greater than or equal to a particular number, for example.

In a case where the finishing condition is not satisfied (S550: NO), the CPU 110 returns the processing to S510 and continues the training. In a case where the finishing condition is satisfied (S550: YES), in S560 the CPU 110 stores data of the trained image generation model GN including the adjusted parameters in the nonvolatile memory 130, and ends the training process.

The output image data OIg generated by the trained image generation model GN indicates a reproduction image DI5 (FIG. 5E) acquired by reconstructing and reproducing the features of the normal image DI2 as the input image. For this reason, the output image data OIg generated by the trained image generation model GN is also referred to as reproduction image data indicating the reproduction image DI5. The reproduction image DI5 of FIG. 5E is approximately the same as the normal image DI2 of FIG. 5B. The trained image generation model GN is trained to reconstruct the features of the normal image DI2. Thus, it is expected that, when abnormal image data indicating the abnormal image DI4a (FIG. 5C) or the abnormal image DI4b (FIG. 5D) is input to the trained image generation model GN, the reproduction image data generated by the trained image generation model GN indicates the normal image DI2. That is, the reproduction image data generated when the abnormal image data is input to the trained image generation model GN indicates the reproduction image DI5 which does not include defects included in the abnormal images DI4a and DI4b (the linear scratch df4a and the stain df4b). In other words, the reproduction image DI5 is an image acquired by reproducing the normal image DI2 as shown in FIG. 5E in both cases where the normal image data is input to the image generation model GN and where the abnormal image data is input to the image generation model GN.

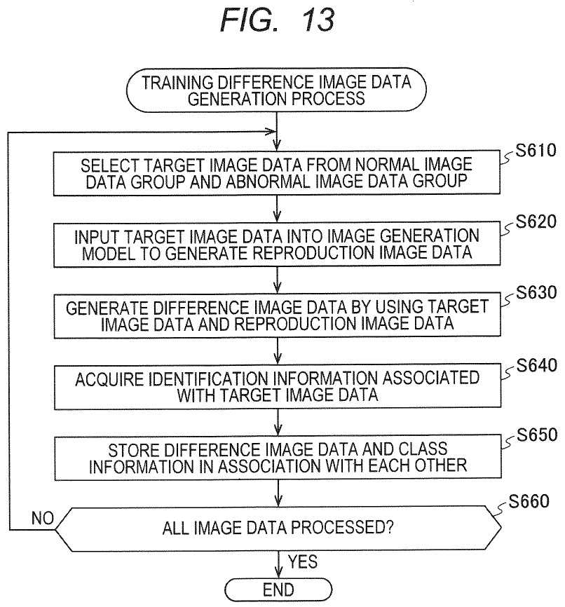

In S30 after the training process of S20 in FIG. 3, the CPU 110 performs a training difference image data generation process. The training difference image data generation process is a process of generating difference image data used for training processes of image discrimination models DN1 and DN2 described later. FIG. 13 is a flowchart of the training difference image data generation process.

In S610, the CPU 110 selects one target image data from the normal image data group and the abnormal image data group stored in the nonvolatile memory 130. In S620, the CPU 110 inputs the target image data to the trained image generation model GN and generates reproduction image data corresponding to the target image data. In a case where the target image data is image data (normal image data or abnormal image data) generated using the artwork image data RD1 of the label L1, the image generation model GN1 for the label L1 is used. In a case where the target image data is image data (normal image data or abnormal image data) generated using the artwork image data RD2 of the label L2, the image generation model GN2 for the label L2 is used.

In S630, the CPU 110 generates difference image data by using the target image data and the reproduction image data corresponding to the target image data. For example, the CPU 110 calculates a difference value (v1-v2) between a component value v1 of a pixel of the image indicated by the target image data and a component value v2 of a pixel of the corresponding reproduction image, and normalizes the difference value to a value in the range of 0 to 1. The CPU 110 calculates the difference value for each pixel and each color component, and generates difference image data having the difference value as the color value of the pixel.

A difference image DI6n shown in FIG. 5F is indicated by the difference image data generated in a case where the target image data is normal image data indicating the normal image DI2 (FIG. 5B). In this case, since the reproduction image DI5 of FIG. 5E and the normal image DI2 of FIG. 5B are substantially the same image, each pixel value of the difference image DI6n is a value close to 0. However, since the reproduction image DI5 of FIG. 5E and the normal image DI2 of FIG. 5B are not completely the same, each pixel value of the difference image DI6n is not completely 0, but is a value that may differ for each pixel, and is a value having variation for each pixel. Hereinafter, the difference image DI6n is also referred to as a normal difference image DI6n, and the difference image data indicating the normal difference image DI6n is also referred to as normal difference image data.

A difference image DI6a in FIG. 5G is indicated by the difference image data generated in a case where the target image data is abnormal image data indicating the abnormal image DI4a (FIG. 5C). In this case, the reproduction image DI5 of FIG. 5E does not include a linear scratch, but the abnormal image DI4a of FIG. 5C includes the linear scratch df4a. Thus, a linear scratch df6a similar to the linear scratch df4a of the abnormal image DI4a appears in the difference image DI6a. The value of each pixel of the portion of the difference image DI6a excluding the linear scratch df6a is a value close to 0, similarly to the normal difference image DI6n.

A difference image DI6b in FIG. 5H is indicated by the difference image data generated in a case where the target image data is abnormal image data indicating the abnormal image DI4b (FIG. 5D). In this case, the reproduction image DI5 of FIG. 5E does not include a stain, but the abnormal image DI4a of FIG. 5D includes the stain df4b. Thus, a stain df6b similar to the stain df4b of the abnormal image DI4b appears in the difference image DI6b. The value of each pixel in the portion of the difference image DI6b excluding the stain df6b is a value close to 0, similarly to the normal difference image DI6n. Hereinafter, the difference images DI6a and DI6b are also referred to as abnormal difference images DI6a and DI6b, and the difference image data indicating the abnormal difference images DI6a and DI6b are also referred to as abnormal difference image data.

In S640, the CPU 110 acquires identification information associated with the target image data. The identification information is information indicating the type of defect included in the image indicated by the target image data. In the present embodiment, the type of defect is any one of normal (no defect), linear scratch, stain, and circular scratch.

In S650, the CPU 110 saves (stores) the generated difference image data and the acquired identification information in the nonvolatile memory 130 in association with each other. The identification information is used as training data in the training process of the image discrimination models DN1 and DN2 described later.

In S660, the CPU 110 determines whether all the image data included in the stored normal image data group and abnormal image data group have been processed. In a case where there is unprocessed image data (S660: NO), the CPU 110 returns the processing to S610. In a case where all the image data have been processed (S660: YES), the CPU 110 ends the training difference image data generation process. The normal difference image data and the abnormal difference image data generated by the training difference image data generation process are also collectively referred to as training difference image data.

In S40 of FIG. 3 after the training difference image data generation process, the CPU 110 performs the training process of the image discrimination model DN1 of S40A and the training process of the image discrimination model DN2 of S40B in parallel. By performing these training processes in parallel, the overall processing time of the inspection preparation process is reduced. The outline of these machine learning models and the training processes will be described below.

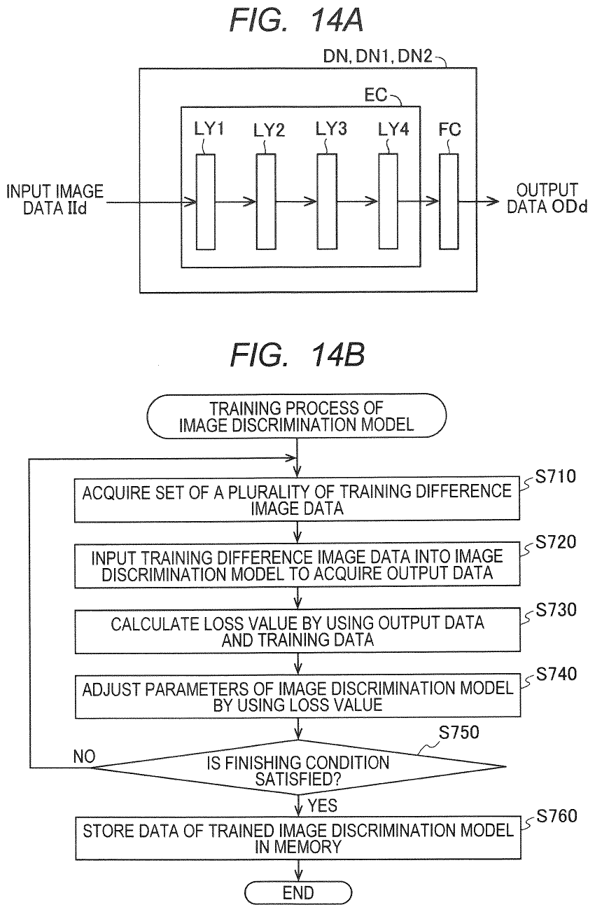

FIG. 14A is a schematic diagram showing an example of the configuration of the image discrimination model DN. The image discrimination models DN1 and DN2 have the same configuration, and thus the configuration of the image discrimination model DN will be described. The image discrimination model DN performs arithmetic processing using a plurality of parameters on input image data IId and generates output data ODd corresponding to the input image data IId. In the present embodiment, the difference image data is used as the input image data IId. In the present embodiment, the output data ODd indicates a discrimination result acquired by discriminating the type (in the present embodiment, any one of normal, linear scratch, stain, and circular scratch) of the defect of the label in the image used for generating the difference image data.

A known model called ResNet18 is used as the image discrimination model DN of the present embodiment. This model is disclosed in, for example, a paper “K. He, X. Zhang, S. Ren, and J. Sun, “Deep residual learning for image recognition,” in ICML, 2016.” The image discrimination model DN includes an encoder EC and a classifier FC. The encoder EC performs a dimension reduction process on the input image data IId to generate feature maps indicating features of the input image indicated by the input image data IId (for example, the difference images DI6n, DI6a, and DI6b of FIGS. 5F to 5H).

The encoder EC includes a plurality of layers LY1 to LY4. Each layer is a convolutional neural network (CNN) including a plurality of convolution layers. Each convolution layer performs a convolution process using a filter of a particular size to generate a feature map. The calculated value of each convolution process is added with a bias, and then input to a particular activation function for conversion. The feature map output from each convolution layer is input to the next processing layer (the next convolution layer or the next layer). As the activation function, a known function such as a so-called ReLU (Rectified Linear Unit) is used. The weights and biases of the filter used in the convolution process are parameters adjusted by the training process described later. Note that the feature maps output from the layers LY1 to LY4 are used in a PaDiM data generation process described later, and thus these feature maps will be supplementarily described in the PaDiM data generation process.

The classifier FC includes one or more fully connected layers. The classifier FC reduces the number of dimensions of the feature map output from the encoder EC to generate the output data ODd. The weights and biases used for the operation of the fully connected layer of the classifier FC are parameters adjusted by the training process described later.

Next, the training process (S40A and S40B in FIG. 3) of the image discrimination model DN will be described. FIG. 14B is a flowchart of the training process of the image discrimination model DN. A plurality of parameters used for the operation of the image discrimination model DN (including a plurality of parameters used for the operation of each of the convolution layers and the fully connected layer) are adjusted by the training. Before the training process, the plurality of parameters are set to initial values such as random values.

In S710, the CPU 110 acquires a plurality of training difference image data of a batch size from the nonvolatile memory 130. Here, the plurality of training difference image data of the batch size are acquired so as to include both the abnormal difference image data and the normal difference image data described above. Since the image discrimination model DN1 is the image discrimination model DN for the label L1, the training difference image data generated using the normal image data and the abnormal image data indicating the label L1 is acquired in the training process of the image discrimination model DN1. Since the image discrimination model DN2 is the image discrimination model DN for the label L2, the training difference image data generated using the normal image data and the abnormal image data indicating the label L2 is acquired in the training process of the image discrimination model DN2. Thereby, the image discrimination model DN1 is trained for the label L1 and the image discrimination model DN2 is trained for the label L2. In S720, the CPU 110 inputs the plurality of training difference image data into the image discrimination model DN, and generates a plurality of output data ODd corresponding to the plurality of training difference image data.

In S730, the CPU 110 calculates a loss value by using the plurality of output data ODd and the plurality of training data corresponding to the plurality of output data ODd. The training data corresponding to the output data ODd is the identification information stored in S650 of FIG. 13 in association with the training difference image data corresponding to the output data ODd. For example, the CPU 110 calculates a loss value indicating a difference between the output data ODd and the training data corresponding to the output data ODd, for each of the plurality of output data ODd.

A particular loss function, for example, a square error is used for calculating the loss value. For the calculation of the loss value, another known loss function for calculating a loss value corresponding to the difference between the output data ODd and the training data, for example, a cross entropy error or an absolute error may be used.

In S740, the CPU 110 adjusts the plurality of parameters of the image discrimination model DN by using the calculated loss value. For example, the CPU 110 adjusts the parameters according to a particular algorithm so as to reduce the total of the loss value calculated for each output data ODd. As the particular algorithm, for example, an algorithm using the error backpropagation method and the gradient descent method is used.

In S750, the CPU 110 determines whether a finishing condition of training is satisfied. As in S450 of FIG. 11B, various conditions are used as the finishing condition. The various conditions include, for example, that the loss value becomes less than or equal to a reference value, that the amount of change in the loss value becomes less than or equal to a reference value, and that the number of times the adjustment of the parameters of S740 is repeated becomes greater than or equal to a particular number.

In a case where the finishing condition is not satisfied (S750: NO), the CPU 110 returns the processing to S710 and continues the training. In a case where the finishing condition is satisfied (S750: YES), in S760 the CPU 110 stores data of the trained image discrimination model DN including the adjusted parameters in the nonvolatile memory 130, and ends the training process.

As described above, the output data ODd generated by the trained image discrimination model DN indicates a discrimination result acquired by discriminating the type (in the present embodiment, any one of normal, linear scratch, stain, and circular scratch) of the defect of the label in the image used for the generation of the difference image data. However, the output data ODd is not used in an inspection process described later. Thus, the image discrimination model DN does not need to be trained to such an extent that the output data ODd accurately discriminates the type of defect. In the inspection process, the feature maps (details will be described later) generated by the encoder EC of the image discrimination model DN are used. For this purpose, the image discrimination model DN is trained to such an extent that the encoder EC of the image discrimination model DN generates feature maps that sufficiently reflect the features of the difference image data.

In S50 of FIG. 3 after the training process of the image discrimination model DN, the CPU 110 performs the PaDiM data generation process for the label L1 of S50A and the PaDiM data generation process for the label L2 of S50B in parallel. By performing these processes in parallel, the entire processing time of the inspection preparation process is reduced. Since the PaDiM data generation process for the label L1 and the PaDiM data generation process for the label L2 are basically the same in processing content, the PaDiM data generation process will be described while appropriately pointing out different parts.

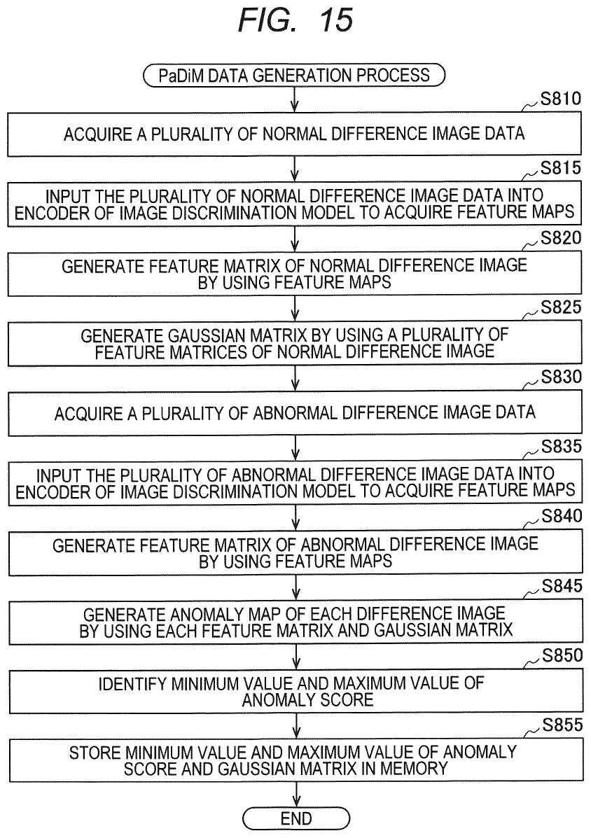

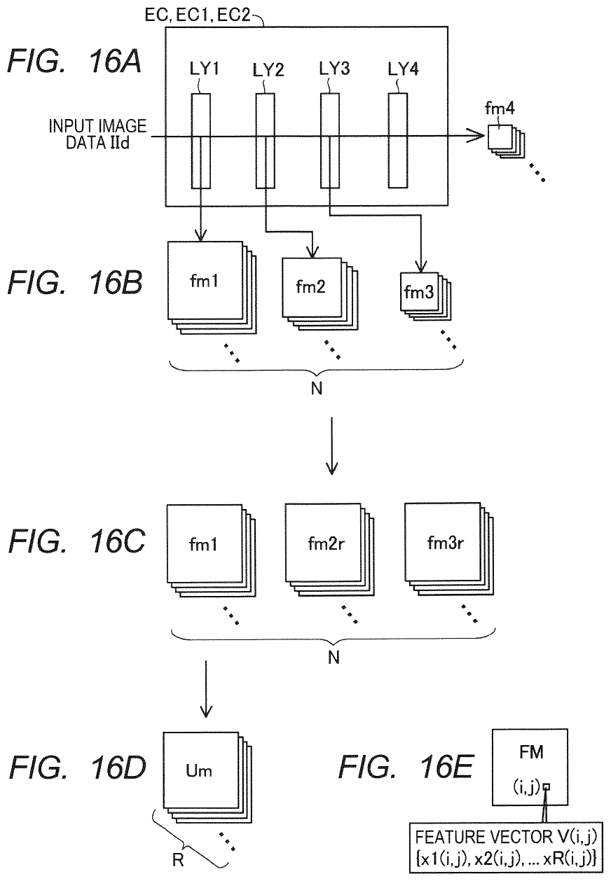

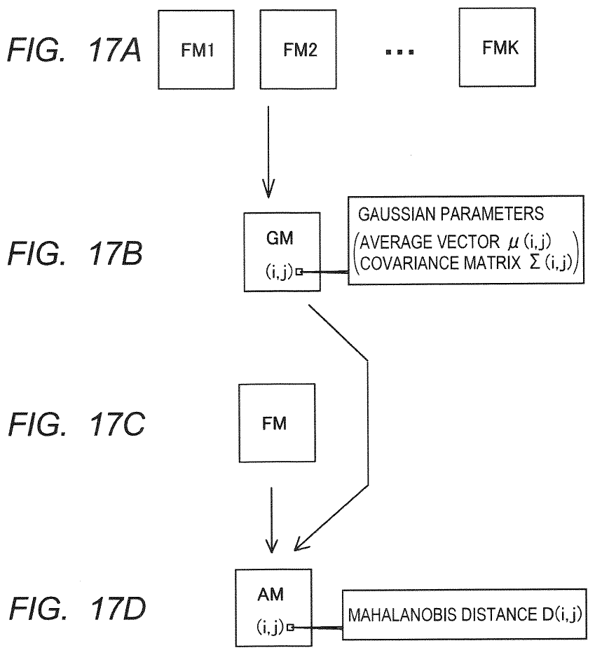

The PaDiM (a Patch Distribution Modeling Framework for Anomaly Detection and Localization) is a mechanism of anomaly detection using a machine learning model, and is disclosed in a paper “T. Defard, A. Setkov, A. Loesch, and R. Audigier, “Padim: a patch distribution modeling framework for anomaly detection and localization”, arXiv: 2011.08785(2020), https://arxiv.org/abs/2011.08785, posting date 17 Nov. 2020”. The PaDim data generation process is a process of generating data for PaDiM (for example, Gaussian matrix GM described later). FIG. 15 is a flowchart of the PaDiM data generation process. FIGS. 16A to 17D are explanatory diagrams of the PaDiM data generation process.

In S810, the CPU 110 acquires a particular number (K) of normal difference image data from the nonvolatile memory 130. The number K of normal difference image data is, for example, an integer of 1 or more, for example, approximately 10 to 100. In the PaDiM data generation process for the label L1, the K normal difference image data are acquired from the normal difference image data generated using the normal image data indicating the label L1. In the PaDiM data generation process for the label L2, the K normal difference image data are acquired from the normal difference image data generated using the normal image data indicating the label L2. The acquired K normal difference image data are selected, for example, at random from the generated hundreds to thousands of normal difference image data. In a modification, the similarities of the generated hundreds to thousands of normal difference image data may be compared using histogram data, for example, and K normal difference image data that are not similar to each other may be selected.

In S820, the CPU 110 inputs each of the acquired normal difference image data as the input image data IId to the encoder of the image discrimination model DN, and acquires N feature maps fm. In the PaDiM data generation process for the label L1, an encoder EC1 of the image discrimination model DN1 for the label L1 is used to acquire the N feature maps fm. In the PaDiM data generation process for the label L2, an encoder EC2 of the image discrimination model DN2 for the label L2 is used to acquire the N feature maps fm.

Here, the N feature maps fm will be described. FIG. 16A shows the encoder EC of the image discrimination model DN, and FIG. 16B shows the feature maps fm generated by the encoder EC.

A first layer LY1 generates n1 feature maps fm1 (FIG. 16B). The n1 feature maps fm1 are input to a second layer LY2. Each feature map fm1 is, for example, image data of 32 pixels×32 pixels. The number (also referred to as the number of channels) n1 of the feature maps fm1 is 64, for example.

The second layer LY2 generates n2 feature maps fm2 (FIG. 16B). The n2 feature maps fm2 are input to a third layer LY3. Each feature map fm2 is, for example, image data of 16 pixels×16 pixels. The number of channels n2 of the feature maps fm2 is 128, for example.

The third layer LY3 generates n3 feature maps fm3 (FIG. 16B). The n3 feature maps fm3 are input to a fourth layer LY4. Each feature map fm3 is, for example, image data of 8 pixels×8 pixels. The number of channels n3 of the feature map fm3 is 256, for example.

The fourth layer LY4 generates n4 feature maps fm4. Each feature map fm4 is, for example, image data of 4 pixels×4 pixels. The n4 feature maps fm4 are not used in the PaDiM data generation process. In this step, a total of N (N is an integer of 3 or more) feature maps fm1 to fm3 generated by the layers LY1 to LY3 are acquired (N=n1+n2+n3, in this embodiment, N=448).

In S820, the CPU 110 generates a feature matrix FM of a normal difference image (for example, the normal difference image DI6n of FIG. 5F) by using the N feature maps fm.

Specifically, the CPU 110 adjusts the size (the number of pixels in the vertical direction and the horizontal direction) of the generated feature maps fm to make the size of all the feature maps fm the same. In the present embodiment, the size of the feature map fm1 generated in the first layer LY1 is the largest among the N feature maps fm (FIG. 16B). Thus, in the present embodiment, the CPU 110 performs a known enlargement process on the feature maps fm2 generated in the second layer LY2 to generate feature maps fm2r having the same size as the feature maps fm1 (FIG. 16C). Similarly, the CPU 110 performs the enlargement process on the feature maps fm3 generated in the third layer LY3 to generate feature maps fm3r having the same size as the feature maps fm1 (FIG. 16C).

The CPU 110 selects R use maps Um to be used for generating the feature matrix FM from among the N feature maps fm after size adjustment that are generated using one normal difference image data (FIG. 16D). The number R of the use maps Um is an integer greater than or equal to 1 and less than or equal to N, and is approximately 50 to 200, for example. The R use maps Um are selected randomly, for example.

The CPU 110 generates the feature matrix FM of one normal difference image by using the selected R use maps Um. The feature matrix FM is a matrix having, as elements, feature vectors V (i, j) having one-to-one correspondence with the pixels of the feature map fm after size adjustment. The coordinates (i, j) indicate the coordinates of the corresponding pixel in the feature map fm. The feature vector is a vector having, as elements, the value of the pixel at coordinates (i, j) in the R use maps Um. As shown in FIG. 16E, one feature vector is an R-dimensional vector (a vector having R elements).

Here, the feature matrix FM of the normal difference image is generated for each normal difference image (each normal difference image data). In the present embodiment, since the number of normal difference image data to be used is K, K feature matrices FM1 to FMK of the normal difference images are generated (FIG. 17A).

In S825, the CPU 110 generates a Gaussian matrix GM of the normal difference image by using the K feature matrices FM1 to FMK of the normal difference image. The Gaussian matrix GM of the normal difference image is a matrix having, as elements, Gaussian parameters having one-to-one correspondence with the pixels of the feature map fm after size adjustment. The Gaussian parameters corresponding to the pixel at coordinates (i, j) include a mean vector μ(i, j) and a covariance matrix Σ(i, j). The mean vector μ(i, j) is a mean of the feature vectors V(i, j) of the K feature matrices FM1 to FMK of the normal difference image. The covariance matrix Σ(i, j) is a covariance matrix of the feature vectors V(i, j) of the K feature matrices FM1 to FMK of the normal difference image. The mean vector μ(i, j) and the covariance matrix Σ(i, j) are statistical data calculated using the K feature vectors V(i, j). One Gaussian matrix GM is generated for the K normal difference image data.

In S830, the CPU 110 acquires a plurality of abnormal difference image data from the nonvolatile memory 130. In the present embodiment, K abnormal difference image data for each of three types of defects (linear scratch, stain, and circular scratch) are acquired at random. Thus, a total of (3×K) abnormal difference image data are acquired. In the PaDiM data generation process for the label L1, the abnormal difference image data is acquired from the abnormal difference image data generated using the abnormal image data indicating the label L1. In the PaDiM data generation process for the label L2, the abnormal difference image data is acquired from the abnormal difference image data generated using the abnormal image data indicating the label L2.

In S835, the CPU 110 inputs each of the acquired abnormal difference image data as the input image data IId to the encoder EC of the image discrimination model DN to acquire N feature maps fin. In the PaDiM data generation process for the label L1, the encoder EC1 of the image discrimination model DN1 for the label L1 is used to acquire the N feature maps fin. In the PaDiM data generation process for the label L2, the encoder EC2 of the image discrimination model DN2 for the label L2 is used to acquire the N feature maps fin.

In S840, the CPU 110 generates a feature matrix FM of the abnormal difference image (for example, the abnormal difference images DI6a and DI6b of FIGS. 5G and 5H) using the acquired N feature maps fin. The process of generating the feature matrix FM is the same as the process described in S820. In the present embodiment, the number of abnormal difference image data that are used is (3×K), and thus, (3×K) feature matrices FM of the abnormal difference image are generated.

In S845, the CPU 110 generates an anomaly map AM of each difference image by using each generated feature matrix FM and the Gaussian matrix GM. By this time, the feature matrix FM has been generated for each of the (4×K) difference images including the K normal difference images and the (3×K) abnormal difference images in S820 and S840. The CPU 110 generates the anomaly map AM (FIG. 17D) of each difference image by using each of the (4×K) difference images as the target difference image (FIG. 17C).

The anomaly map AM of FIG. 17D is image data having the same size as the feature map fm after the size adjustment. The value of each pixel of the anomaly map AM is a Mahalanobis distance. A Mahalanobis distance D(i, j) at the coordinates (i, j) is calculated by performing a calculation process according to a known equation by using the feature vector V(i, j) of the feature matrix FM of the target difference image, and the mean vector μ(i, j) and the covariance matrix Σ(i, j) of the Gaussian matrix GM of the normal image. The Mahalanobis distance D(i, j) is an evaluation value indicating the degree of difference between the K normal difference images and the target difference image at the coordinates (i, j). Thus, the Mahalanobis distance D(i, j) is a value indicating the degree of abnormality (anomaly score) of the target difference image at the coordinates (i, j). The difference between the K normal difference images and the target difference image reflects the difference between the K normal images that are the sources of the K normal difference images and the image (normal image or abnormal image) that is the source of the target difference image. Thus, the Mahalanobis distance D(i, j) is an evaluation value indicating the degree of difference between the K normal images at the coordinates (i, j) and the image that is the source of the target difference image.

In the present embodiment, (4×K) difference images (difference image data) are used, and thus, the (4×K) anomaly maps AM are generated.

In S850, the CPU 110 identifies a maximum value Amax and a minimum value Amin of the anomaly score of the (4×K) anomaly maps AM. That is, the maximum value and the minimum value of the values of all the pixels of the (4×K) anomaly maps AM are identified as the maximum value Amax and the minimum value Amin of the anomaly score.

In S855, the CPU 110 stores the Gaussian matrix GM of the normal difference image and the maximum value Amax and the minimum value Amin of the anomaly score in the nonvolatile memory 130 as PaDiM data, and ends the PaDiM data generation process. The PaDiM data for the label L1 is generated in the PaDiM data generation process for the label L1 of S50A, and the PaDiM data for the label L2 is generated in the PaDiM data generation process for the label L2 of S50. When the PaDiM generation process ends, the inspection preparation process of FIG. 3 ends.

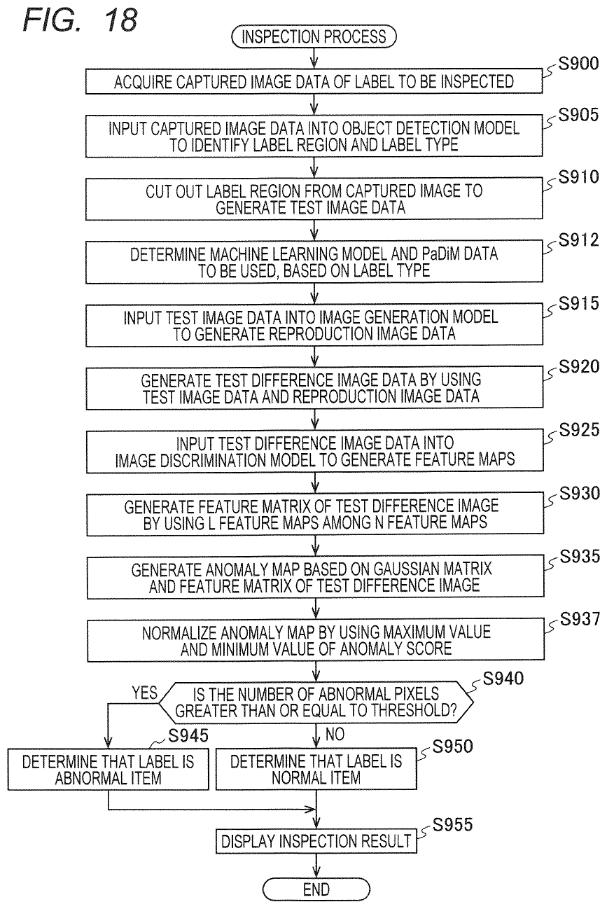

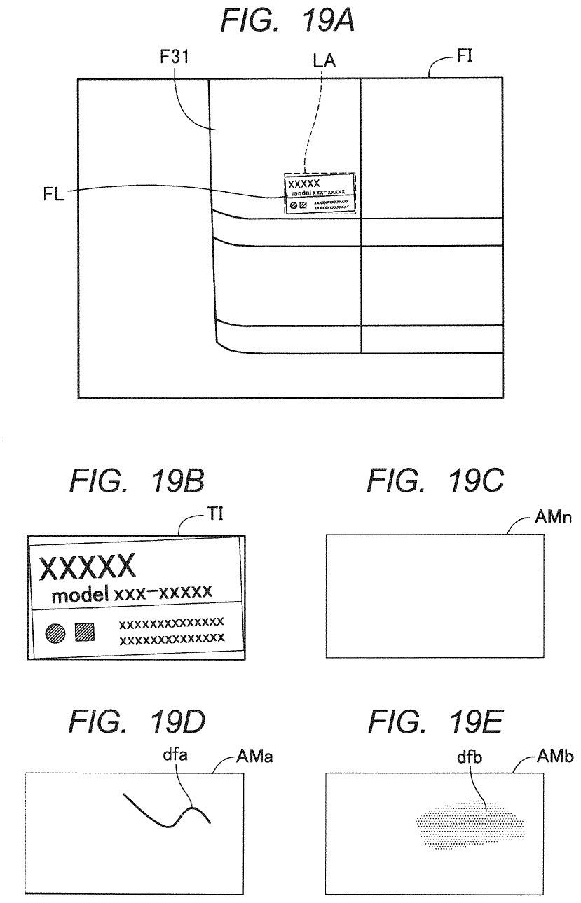

FIG. 18 is a flowchart of the inspection process. FIGS. 19A to 19E are images for explaining the inspection process. The inspection process is a process of inspecting whether the label L to be inspected (in the present embodiment, the label L1 or the label L2 of FIG. 2B) is an abnormal item including a defect and so on or a normal item not including a defect and so on. The inspection process is performed for each label L. The inspection process is started when a user (for example, an operator of the inspection) inputs a process start instruction to the inspection apparatus 100 via the operation interface 150. For example, the user inputs the start instruction of the inspection process in a state where the product 300 to which the label L to be inspected is affixed is arranged at a particular position for capturing an image by using the image capturing device 400.

In S900, the CPU 110 acquires captured image data indicating a captured image including the label L to be inspected (hereinafter, also referred to as an inspection item). For example, the CPU 110 transmits a capturing instruction to the image capturing device 400 to cause the image capturing device 400 to generate captured image data, and acquires the captured image data from the image capturing device 400. As a result, for example, captured image data indicating a captured image FI of FIG. 19A is acquired.

The captured image FI is an image showing a front surface F31 of the product and a label FL affixed to the front surface F31. In this way, the front surface of the product and the label shown in the captured image FI are referred to as the front surface F31 and the label FL using reference numerals with “F” added to the head of the reference numerals in order to distinguish from the front surface 31 and the label L (FIG. 2A) of the actual product.

In S905, the CPU 110 inputs the acquired captured image data to the object detection model AN, and identifies a label region LA in which the label FL is located in the captured image FI and the type of the label FL (either the label L1 or L2). Specifically, the CPU 110 inputs the captured image data as the input image data IIa (FIG. 11A) to the object detection model AN, and generates the output data OD (FIG. 11A) corresponding to the captured image data. The CPU 110 identifies prediction region information including the confidence Vc greater than or equal to a particular threshold THa among (S×S×Bn) prediction region information included in the output data OD, and identifies a prediction region indicated by the prediction region information as the label region LA. In a case where two or more label regions LA overlapping each other are identified, for example, a known process called “non-maximal suppression” is performed to identify one label region LA from the two or more label regions. For example, in the example of FIG. 19A, the label region LA that includes the entire label FL and substantially circumscribes the label FL is identified in the captured image FL. The CPU 110 identifies the type of the label FL in the label region LA based on the class information corresponding to the label region LA, among the class information included in the output data OD.

In S910, the CPU 110 generates test image data indicating a test image TI by using the captured image data. Specifically, the CPU 110 cuts out the label region LA from the captured image FI to generate the test image data. The test image TI of FIG. 19B shows an image in the label region LA (that is, an image of the label FL). The label FL of the test image TI of FIG. 19B does not include a defect such as a scratch, but may include a defect such as a scratch.

In S912, the CPU 110 determines machine learning models (the image generation model GN and the image discrimination model DN) to be used and PaDiM data (Gaussian matrix GM and the maximum value Amax and the minimum value Amin of the anomaly score) based on the type of the identified label FL. In a case where the label FL is identified as the label L1, the image generation model GN1 and the image discrimination model DN1 for the label L1 are determined as the machine learning models to be used, and the PaDiM data for the label L1 is determined as the PaDiM data to be used. In a case where the label FL is identified as the label L2, the image generation model GN2 and the image discrimination model DN2 for the label L2 are determined as the machine learning models to be used, and the PaDiM data for the label L2 is determined as the PaDiM data to be used.

In S915, the CPU 110 inputs the test image data into the image generation model GN to be used, and generates reproduction image data corresponding to the test image data. The reproduction image indicated by the reproduction image data is, for example, an image acquired by reproducing the label FL of the input test image as described with reference to FIG. 5E. Even in a case where the label FL of the test image includes a defect such as a scratch, the reproduction image does not include the defect.

In S920, the CPU 110 generates difference image data by using the test image data and the reproduction image data. The processing for generating the difference image data is the same as the processing for generating the difference image data by using the target image data and the reproduction image data, which has been described in S630 of FIG. 13. The reproduction image data generated in this step is also referred to as test difference image data, and an image indicated by the test difference image data is also referred to as a test difference image. In a case where the label FL of the test image does not include a defect, the test difference image is an image that does not include a defect, similarly to the normal difference image DI6n of FIG. 5F. In a case where the label FL of the test image includes a defect, the test difference image is an image including a defect, similarly to the abnormal difference images DI6a and DI6b of FIGS. 5G and 5H.

In S925, the CPU 110 inputs the acquired test difference image data to the encoder EC of the image discrimination model DN to be used, thereby generating N feature maps fm corresponding to the test difference image data (FIG. 16B).

In S930, the CPU 110 generates the feature matrix FM of the test difference image by using the N feature maps fm. Specifically, the CPU 110 generates the feature matrix FM (FIG. 16E) of the test difference image by using R use maps Um (FIG. 16D) selected at the time of training the image discrimination model DN, among the N feature maps.

In S935, the CPU 110 generates the anomaly map AM (FIG. 17D) using the Gaussian matrix GM (FIG. 17B) to be used and the feature matrix FM of the test difference image. The method of generating the anomaly map AM is the same as the method of generating the anomaly map AM in S845 of FIG. 15 described with reference to FIGS. 17B to 17D.

In S937, the CPU 110 normalizes the anomaly map AM by using the maximum value Amax and the minimum value Amin of the anomaly score. The maximum value Amax and the minimum value Amin of the anomaly score are values identified in S850 of FIG. 15 in the PaDiM data generation process described above. The normalization of the anomaly map AM is performed by converting the values of the plurality of pixels of the anomaly map AM (that is, the anomaly score) from an anomaly score before normalization Ao to an anomaly score after normalization As. The anomaly score after normalization As is calculated according to the following Equation (1) using the anomaly score before normalization Ao, the maximum value Amax, and the minimum value Amin. In the anomaly map AM after normalization, the anomaly score of each pixel is a value in the range of 0 to 1.

As=(As−Amin)/(Amax−Amin) (1)

An anomaly map AMn of FIG. 19C is an example of the anomaly map generated in a case where the inspection item is a normal item, for example. An anomaly map AMa of FIG. 19D is an example of the anomaly map generated in a case where the inspection item is an abnormal item having a linear scratch, for example. An anomaly map AMb of FIG. 19E is an example of the anomaly map generated in a case where the inspection item is an abnormal item having stain, for example. The anomaly map AMn of FIG. 19C does not include an abnormal pixel. In the anomaly map AMa of FIG. 19D, a linear scratch dfa formed of a plurality of abnormal pixels appears. In the anomaly map AMb of FIG. 19E, a stain dfb formed of a plurality of abnormal pixels appears. The abnormal pixels are, for example, pixels having an anomaly score greater than or equal to a threshold TH1. In this way, by referring to the anomaly map AM, the position, size, and shape of a defect such as a scratch included in the test image are identified. In a case where the test image does not include a defect such as a scratch, no region of a defect is identified in the anomaly map AM.

In S940, the CPU 110 determines whether the number of abnormal pixels in the anomaly map AM is greater than or equal to a threshold TH2. In a case where the number of abnormal pixels is less than the threshold TH2 (S940: NO), in S950 the CPU 110 determines that the label as the inspection item is a normal item. In a case where the number of abnormal pixels is greater than or equal to the threshold TH2 (S940: YES), in S945 the CPU 110 determines that the label as the inspection item is an abnormal item. In S955, the CPU 110 displays the inspection result on the display 140, and ends the inspection process. In this way, it is determined whether the inspection item is a normal item or an abnormal item by using the machine learning models AN, GN, and DN.

According to the present embodiment described above, the CPU 110 of the inspection apparatus 100 generates the reproduction image data by inputting the test image data indicating the test image TI including the label FL of the inspection target into the image generation model GN (S915 in FIG. 18). The CPU 110 generates the test difference image data by using the test image data and the reproduction image data (S920 in FIG. 18). The CPU 110 inputs the test difference image data into the encoder EC of the image discrimination model DN, thereby generating the feature matrix FM indicating the feature of the test difference image data (S925 and S930 in FIG. 18). The CPU 110 detects a difference (specifically, a defect) between the label of the inspection target and the normal label by using the feature matrix FM. As a result, a difference between the label of the inspection target and the normal label is detected by using the image discrimination model DN (encoder EC).

For example, in a case where the test image includes noise or where the difference between the label of the inspection target and the normal label is relatively small, even if the test image data or the normal image data is input to the image discrimination model DN (encoder EC) as it is to generate the feature matrix FM, the presence or absence of the difference between the test image data and the normal image data (for example, the presence or absence of a defect) may not be reflected in the feature matrix FM in some cases. In this case, even if the difference between the label of the inspection target and the normal label is detected by using these feature matrices FM, the difference may not be detected accurately. In contrast, in the difference image, the difference between the test image and the normal image is further emphasized, in other words, the difference between the label of the inspection target and the normal label is further emphasized. For this reason, in the present embodiment, the test difference image data is input to the encoder EC to generate the feature matrix FM. As a result, the difference between the label of the inspection target and the normal label may be accurately detected by using these feature matrices FM.

More specifically, the CPU 110 detects a difference between the label of the inspection target and the normal label by using the feature matrix FM indicating the feature of the test difference image data and the Gaussian matrix GM (S935 to S950 in FIG. 18). The Gaussian matrix GM is data based on the feature matrix FM generated by inputting the normal difference image data to the image discrimination model DN (encoder EC) (S815 to S825 in FIG. 15). The normal difference image data is image data indicating the difference between the normal image DI2 (FIG. 5B) and the reproduction image DI5 (FIG. 5E) corresponding to the normal image DI2 (610 to S630 in FIG. 13). Thus, the difference between the label of the inspection target and the normal label may be accurately detected by comparing the feature matrix FM of the test difference image data with the feature matrix FM of the normal difference image data.

According to the present embodiment, the feature matrix FM of the test difference image data and the normal difference image data includes the feature vector V(i,j) calculated for each unit region (a region corresponding to one pixel of the feature map fm) in an image with respect to the test difference image data. The feature vector V (i, j) is a vector having, as elements, values based on respective ones of the plurality of feature maps fm acquired by inputting the test difference image data and the normal difference image data to the encoder EC (FIG. 16E). The Gaussian matrix GM is data indicating an average vector and a covariance matrix of a plurality of feature vectors V (i, j) calculated for each unit region of an image with respect to a plurality of normal difference image data (FIG. 17B). The CPU 110 generates the anomaly map AM acquired by calculating the anomaly score (specifically, Mahalanobis distance) for each unit region in the image by using the feature matrix FM of the test difference image data and the Gaussian matrix GM (S935 in FIG. 18, FIG. 17D). The CPU 110 detects a difference (for example, a defect) between the label of the inspection target and the normal label based on the anomaly map AM (S940 to S950 in FIG. 18). As a result, the difference between the label of the inspection target and the normal label may be accurately detected by using the anomaly map AM acquired by calculating the Mahalanobis distance as the anomaly score using the feature matrix FM and the Gaussian matrix GM. Further, for example, the position and the range where the defect exists may be easily identified by using the anomaly map AM.

According to the present embodiment, the plurality of normal image data used for the training process of the image generation model GN are image data acquired by performing image processing on the artwork image data RD1 and RD2 used for producing the label L (FIG. 6). As a result, a plurality of normal image data may be easily prepared, and thus the burden for training the image generation model GN is reduced. For example, in a case where captured image data are used as the plurality of normal image data, the user needs to capture the normal label L, and thus the burden on the user increases. In particular, in a case where the number of necessary normal image data is large, the burden on the user may increase excessively. Since the artwork image data RD1 and RD2 are image data used for producing the label L, the user does not need to prepare image data exclusively for the training process of the image generation model GN. Thus, the burden on the user is reduced.

According to the present embodiment, the reproduction image data used for generating the normal difference image data is generated using the image generation model GN trained using the normal image data, similarly to the reproduction image data used for generating the test difference image data. In this way, since the normal difference image data is generated using the same image generation model GN as that used to generate the test difference image data, the characteristics of the same image generation model GN are reflected in both the normal difference image data and the test difference image data. As a result, the normal difference image data may be appropriately generated such that the difference between the normal difference image data and the test difference image data is not a difference caused by the characteristics of the image generation model GN but a difference caused by the difference between the label of the inspection target and the normal label (for example, the presence or absence of a defect). Thus, the training process of the image discrimination model DN and the generation of the PaDiM data may be performed using the appropriate normal difference image data. Thus, the feature matrix FM and the Gaussian matrix GM may be generated so as to appropriately reflect the difference between the normal image and the test image, and thus the difference between the test image and the normal image may be detected more accurately.

According to the present embodiment, the plurality of training difference image data used for the training process of the image discrimination model DN are image data indicating the difference between the first image data generated by performing image processing on the artwork image data RD1 and RD2 (normal image data and abnormal image data) and the second image data generated by inputting the first image data to the image generation model GN (reproduction image data acquired by reproducing normal and abnormal images), (S610 to S630 in FIG. 13). As a result, the image discrimination model DN may be appropriately trained such that the encoder EC of the image discrimination model DN extracts the features of the test difference image data and the normal difference image data.

According to the present embodiment, the first image data includes the abnormal image data generated by performing image processing including the defect addition process (S255 in FIG. 7) of adding any one of the plurality of types of defects (linear scratch, stain, and circular scratch in the present embodiment) to the image on the artwork image data RD1 and RD2. The image discrimination model DN is trained to discriminate the type of defect included in the abnormal image (for example, the abnormal images DI4a and DI4b of FIGS. 5C and 5D) indicated by the abnormal image data in a case where the abnormal difference image data generated using the abnormal image data is input (S640 and S650 of FIG. 13 and S730 of FIG. 14B). For example, the task of identifying not only the presence or absence of defect, but also the type of the defect, is more advanced than the task of identifying the presence or absence of defect. Further, the characteristics of the defect greatly differ depending on the type of the defect (scratch, stain, and so on). Thus, by training the image discrimination model DN so as to achieve a more advanced task, the image discrimination model DN may be trained to accurately extract features of various defects. As a result, the image discrimination model DN may be trained such that the encoder EC of the image discrimination model DN appropriately extracts the feature of the defect included in the abnormal difference image data. Thus, the difference between the test image and the normal image may be detected more accurately by using the feature matrix FM and the Gaussian matrix GM generated by using the image discrimination model DN.

According to the present embodiment, the CPU 110 calculates the anomaly map AM of the test difference image by using the Gaussian matrix GM, which is statistical data calculated by using the plurality of feature matrices FM calculated for respective ones of the plurality of normal difference image data, and the feature matrix FM of the test difference image data (S845 in FIG. 15). Then, the CPU 110 detects the difference between the label of the inspection target and the normal label by using the maximum value Amax and the minimum value Amin of the anomaly score in the anomaly map AM calculated in the same manner for each of the plurality of normal difference image data and the plurality of abnormal difference image data, and the anomaly map AM of the test difference image (S937 to S950 in FIG. 18). As a result, for example, the anomaly map AM is evaluated with an appropriate reference in consideration of the variation in the anomaly score in the anomaly map AM calculated in the same manner for each of the plurality of normal difference image data and the plurality of abnormal difference image data, and so on. Thus, the difference between the label of the inspection target and the normal label is appropriately detected. For example, in the present embodiment, the CPU 110 normalizes the anomaly map AM using the maximum value Amax and the minimum value Amin, and determines whether the label in the test image is an abnormal item or a normal item by using the normalized anomaly map AM. In the anomaly map AM before normalization, the range of values that the anomaly score takes is unknown. Thus, in a case where the anomaly map AM before normalization is used, for example, it is relatively difficult to appropriately determine the threshold TH1 for determining whether a pixel is an abnormal pixel. In contrast, in the present embodiment, the anomaly map AM is normalized such that the anomaly score falls within the range of 0 to 1, by using the maximum value Amax and the minimum value Amin based on a relatively large number of samples of the anomaly map AM. Thus, it is appropriately determined whether the label in the test image is an abnormal item or a normal item by using the one fixed threshold TH1. For example, the variation of the determination criterion for each inspection process is suppressed, and it is determined whether the label in the test image is an abnormal item or a normal item based on the stable determination criterion.

According to the present embodiment, the CPU 110 inputs captured image data indicating the captured image FI (FIG. 19A) including the label FL of the inspection target to the object detection model AN, and thereby identifies the label region LA in the captured image FI (S905 in FIG. 18). The CPU 110 generates test image data indicating the test image TI including the label region LA by using the captured image data (S910 in FIG. 18). The object detection model AN is a machine learning model (FIG. 11B) trained by using the composite image data indicating the composite image CI (FIG. 9B) and the label region information indicating the region where the label BL2 is located in the composite image CI. The composite image data indicates the composite image CI that is acquired by combining the normal image DI2 with the background image BI, using the normal image data indicating the normal image DI2 and the background image data indicating the background image BI. The normal image data is image data based on the artwork image data RD1 and RD2 (FIGS. 6 and 5B). The label region information is generated based on the composition information used when the normal image DI2 is combined with the background image BI (S355 in FIG. 10). The composition information includes position information indicating a composition position of the normal image DI2. As a result, the label region information indicates the region where the label BL2 is located more accurately than in a case of using information indicating a region designated by the user as the operator, for example. Thus, the object detection model AN is trained to detect the label region accurately. Accurate detection of the label region suppresses the situation where an excessively large amount of background is included in the test image TI or a part of the label is not included in the test image TI, and thus appropriate test image data is generated. By using appropriate test image data, for example, in the inspection process, the presence or absence of a defect of the label of the inspection target is accurately detected. In addition, since the user does not need to designate a label region at the time of training, the burden on the user is reduced.

In the present embodiment, the object detection model AN is one machine learning model trained to identify both the label L1 and the label L2 (S20A and so on, in FIG. 3). The image generation model GN includes the image generation model GN1 for the label L1 and the image generation model GN2 for the label L2. The image generation model GN1 is a machine learning model trained to generate reproduction image data corresponding to the normal image data indicating the label L1 (S20B in FIG. 3). The image generation model GN2 is a machine learning model trained to generate reproduction image data corresponding to the normal image data indicating the label L2 (S20C in FIG. 3). In the inspection process, the CPU 110 identifies the label region LA using one object detection model AN in both cases where the label L of the inspection target is the label L1 and where the label L of the inspection target is the label L2 (S905 in FIG. 18). The CPU 110 generates the reproduction image data by using the image generation model GN1 for the label L1 in a case where the label L of the inspection target is the label L1, and generates the reproduction image data by using the image generation model GN2 for the label L2 in a case where the label L of the inspection target is the label L2 (S912 and S915 in FIG. 18).

Since the task of identifying the label region is not closely related to the detailed configuration itself in the label, the label is identified with sufficient accuracy even when a plurality of types of labels are identified using one object detection model AN. In contrast, in the task of generating the reproduction image of the label, it is necessary to reproduce the configuration of the label sufficiently in detail and not to reproduce the defect of the label, and thus the dedicated image generation model GN is trained for each type of label. In the present embodiment, the inspection process is performed using one common object detection model AN regardless of the type of the label and a dedicated image generation model GN for each type of the label. As a result, the difference between the normal label and the label including the defect is detected with sufficient accuracy while suppressing excessive increase of the burden of training the machine learning models and the data amount of the machine learning models.

According to the present embodiment, the image discrimination model DN includes the image discrimination model DN1 for the label L1 and the image discrimination model DN2 for the label L2. The image discrimination model DN1 is a machine learning model trained to generate the feature maps fm indicating features of difference image data generated using image data (normal image data and abnormal image data) indicating the label L1 (S40A in FIG. 3). The image discrimination model DN2 is a machine learning model trained to generate the feature maps fm indicating features of difference image data generated using image data (normal image data and abnormal image data) indicating the label L2 (S40B in FIG. 3). In the inspection process, the CPU 110 generates the feature maps fm and the feature matrix FM by using the image discrimination model DN1 for the label L1 in a case where the label L of the inspection target is the label L1, and generates the feature maps fm and the feature matrix FM by using the image discrimination model DN2 for the label L2 in a case where the label L of the inspection target is the label L2 (S912, S925, and S930 in FIG. 18).

Since the task of extracting features of labels and defects in labels using difference image data needs to extract features of labels themselves and features of defects so as to distinguish between both features, a dedicated image discrimination model DN is trained for each type of label. In the present embodiment, the inspection process is performed by using a dedicated image discrimination model DN for each type of label. As a result, the difference between the normal label and the label including the defect is detected with sufficient accuracy.

According to the present embodiment, the image generation model GN is trained by using the normal image data used for generating the composite image data (FIG. 12B). The image discrimination model DN is trained by using the normal difference image data generated using the normal image data used for generating the composite image data (FIG. 14B). As a result, the training of the object detection model AN, the image generation model GN, and the image discrimination model DN is performed by using the normal image data, or the composite image data or the difference image data generated using the normal image data. This reduces the burden of preparing image data for the training process of the plurality of machine learning models. Specifically, since the normal image data are easily generated using the artwork image data RD1 and RD2, the load for preparing image data for the training process is significantly reduced as compared with the case of using image data generated by capturing images, for example.

The test difference image data of the present embodiment is an example of first difference image data, and the normal difference image data is an example of second difference image data. The test image data of the present embodiment is an example of target image data, the normal image data is an example of comparison image data and first training image data, the abnormal image data is an example of defect-added image data, and the composite image data is an example of second training image data. The image discrimination model DN (encoder EC) of the present embodiment is an example of a feature extraction model, the feature matrix FM is an example of first feature data and second feature data, and the Gaussian matrix GM is an example of reference data and statistical data. The artwork image data RD1 and RD2 of the present embodiment are examples of original image data, and the captured image data is an example of original image data.

While the present disclosure has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the present disclosure, and not limiting the present disclosure. Various changes may be made without departing from the spirit and scope of the disclosure. Thus, the disclosure is intended to embrace all known or later developed alternatives, modifications, variations, improvements, and/or substantial equivalents. Some specific examples of potential alternatives, modifications, or variations in the described disclosure are provided below.

(1) In the above-described embodiment, the CPU 110 detects a defect of the label of the inspection target by using the PaDiM mechanism. Alternatively, another mechanism may be used to detect a defect in the label of the inspection target. For example, a defect of the label of the inspection target may be detected by analyzing the feature maps fm acquired by inputting the test difference image data to the image discrimination model DN using a known mechanism of Grad-CAM or Guided Grad-CAM.

(2) The object of the inspection target is not limited to a label affixed to a product (for example, a multifunction peripheral, a sewing machine, a cutting machine, a portable terminal, and so on), and may be any object. The object of the inspection target may be, for example, a label image printed on a product. The object of the inspection target may be a product itself or an arbitrary part of the product such as a tag, an accessory, a part, or a mark attached to the product. Depending on the object of the inspection target, for example, the normal image data and the abnormal image data may be generated by using design drawing data used for production of a product instead of the artwork image data RD.

(3) The configurations of the machine learning models AN, GN, and DN used in the above-described embodiment are merely examples, and other models may be used.

For example, the object detection model AN may be any other model instead of the YOLO model. The object detection model may be, for example, a modified YOLO model such as “YOLO v3”, “YOLO v4”, “YOLO v5”, and so on. Other models may also be used, such as SSD, R-CNN, Fast R-CNN, Faster R-CNN, Mask R-CNN, and so on.

The image generation model GN is not limited to a normal autoencoder. For example, a VQ-VAE (Vector Quantized Variational Auto Encoder) or VAE (Variational Autoencoder) may be used, or an image generation model included in so-called GAN (Generative Adversarial Networks) may be used.

The image discrimination model DN may be any image discrimination model including at least an encoder including CNN, for example, VGG16 or VGG19.

Even in a case where any machine learning generation model is used, the configuration and the number of layers of the specific layers such as the convolution layer and the transposed convolution layer may be appropriately changed. Further, the post-processing performed on values output in each layer of the machine learning model may also be changed as appropriate. For example, the activation function used for the post-processing may be any function, such as ReLU, LeakyReLU, PReLU, softmax, or sigmoidal, for example.

(4) The training process of the machine learning models AN, GN, and DN used in the above-described embodiment is an example, and may be changed as appropriate.

For example, the normal image data and the abnormal image data used for the training process of the image generation model GN may be image data cut out from captured image data acquired by actually capturing the normal label or the label including the defect, instead of image data generated using the artwork image data RD1 and RD2. The same applies to the normal image data and the abnormal image data used for generating the difference image data used in the training process of the image discrimination model DN.

Instead of the composite image data used in the training process of the object detection model AN, captured image data acquired by capturing an image of a product to which a label is actually affixed may be used. Alternatively, image data acquired by combining captured image data acquired by capturing an image of a label and background image data may be used.

In the above-described embodiment, the difference image data used in the training process of the image discrimination model DN is generated by using the normal image data and the reproduction image data acquired by inputting the normal image data to the image generation model GN. Alternatively, for example, the difference image data may be generated by using reproduction image data generated using an image generation model different from the image generation model GN used in the inspection process. The abnormal difference image data may be, for example, image data acquired by adding a pseudo defect to the difference image indicated by the normal difference image data.

In the above-described embodiment, the image discrimination model DN is trained to discriminate the type of defect, but may be trained to discriminate the presence or absence of a defect.

In the embodiment, the training processes of the object detection model AN and the image generation models GN1 and GN2 are performed in parallel by one inspection apparatus 100. Alternatively, the training processes of the object detection model AN and the image generation models GN1 and GN2 may be sequentially performed one at a time by one inspection apparatus, or may be performed by apparatuses different from each other. The same applies to the training process of the image discrimination models DN1 and DN2. The same applies to the PaDiM data generation process for the label L1 and the PaDiM data generation process for the label L2.

(5) In the above-described embodiment, the image discrimination model DN is used as a feature extraction model for generating the feature matrix FM. Alternatively, for example, an autoencoder similar to the image generation model GN may be trained to reproduce normal difference image data or abnormal difference image data when the normal difference image data or the abnormal difference image data is input, and the feature matrix FM may be generated by using an encoder included in the autoencoder. Alternatively, the feature matrix FM may be generated by using an encoder included in an image generation model trained to perform style transfer of normal difference image data into abnormal difference image data using the mechanism of the GAN (Generative Adversarial Network).

(6) The inspection process of FIG. 18 is an example, and may be changed as appropriate. For example, the number of types of labels of the inspection target is not limited to two, and may be one or any number of three or more types. The number of image discrimination models DN and image generation models GN to be used is changed in accordance with the number of types of labels.

In a case where captured image data indicating captured image similar to the test image TI is acquired by adjusting the arrangement of the label of the inspection target at the time of image capturing or the installation position of the image capturing device 400, identification of the region using the object detection model AN or the cutout of the captured image (S905 and S910 in FIG. 18) may be omitted.

The normalization of the anomaly map AM of S937 in FIG. 18 may be omitted. In this case, the presence or absence of a defect may be determined using the anomaly map AM before normalization. In this case, in the PaDiM data generation process, S830 to S850 in FIG. 15 may be omitted.

In the embodiment, the anomaly map AM having the Mahalanobis distance as elements is employed as data indicating the difference between the normal difference image and the test difference image. The data indicating the difference may be data generated using another method. For example, the data indicating the difference may be a map having the Euclidean distance between the average vector μ(i, j) of the normal image and the feature vector V(i, j) of the test image as elements.

In the inspection process, the method of detecting a defect in the label may be changed as appropriate. For example, the CPU 110 may determine the presence or absence of a defect without using the PaDiM method. For example, the CPU 110 may use test difference image data acquired by test image data and reproduction image data acquired by inputting the test image data to the image generation model GN, and identify a pixel having a difference greater than or equal to a reference value as an abnormal pixel among pixels constituting the difference image.

The CPU 110 may determine the presence or absence of a defect without using the test difference image data. Specifically, the CPU 110 may generate the feature matrix FM of the test image data by inputting the test image data to the image discrimination model DN, and determine the presence or absence of a defect in accordance with the PaDiM method using the feature matrix FM. In this case, in the PaDiM data generation process, the normal image data (instead of the normal difference image data) is input into the image discrimination model DN to generate the feature matrix FM of the normal image data, and the Gaussian matrix GM is generated by using the feature matrix FM.

In the embodiment, it is assumed that the object detection model AN identifies one label region LA in the captured image FL. Alternatively, the object detection model AN may identify a plurality of label regions in the captured image FL. In this case, a plurality of test image data indicating images of the respective label regions may be generated, and the plurality of labels may be inspected using the plurality of test image data.

In the above-described embodiment, the object detection model AN is trained to identify the label regions of both the label L1 and the label L2. Alternatively, the object detection model AN may include an object detection model for the label L1 and an object detection model for the label L2. In this case, in the inspection process, when the label L1 is inspected, the label region is identified using the object detection model for the label L1, and when the label L2 is inspected, the label region is identified using the object detection model for the label L2.

In the above-described embodiment, the image generation model GN may be trained to reproduce normal images of both the label L1 and the label L2. In this case, in the inspection process, one common image generation model GN is used in both of the case of inspecting the label L1 and the case of inspecting the label L2. Similarly, the image discrimination model DN may be trained to extract features of difference image data of both the label L1 and the label L2. In this case, in the inspection process, one common image discrimination model DN is used in both of the case of inspecting the label L1 and the case of inspecting the label L2. In the PaDiM data generation process, the Gaussian matrix GM for the label L1 and the Gaussian matrix GM for the label L2 are generated by using one common image discrimination model DN.

(7) The inspection process of the above-described embodiment is used for detecting anomalies such as defects. The present disclosure is not limited to this, and may be used for various processes of detecting a difference between an object of an inspection target and an object of a comparison target. For example, the inspection process of the present embodiment may be used for a process of detecting the presence or absence of an intruder by detecting a difference between a room being captured and a room with no person in an image of a monitoring camera, a process of detecting a temporal change or a motion of an object based on a difference between a current object and a past object, and so on.

(8) In the above-described embodiment, the inspection preparation process and the inspection process are performed by the inspection apparatus 100 of FIG. 1. Alternatively, the inspection preparation process and the inspection process may be performed by different apparatuses. In this case, for example, the machine learning models AN, DN, and GN trained by the inspection preparation process and the PaDiM data are stored in a memory of the apparatus that performs the inspection process. All or some of the inspection preparation process and the inspection process may be performed by a plurality of computers (for example, so-called cloud servers) that communicate with each other via a network. The computer program for performing the inspection process and the computer program for performing the inspection preparation process may be different computer programs.

(9) In each of the embodiment and modifications described above, a part of the configuration realized by hardware may be replaced by software, and conversely, a part or all of the configuration realized by software may be replaced by hardware. For example, all or some of the inspection preparation process and the inspection process may be performed by a hardware circuit such as an ASIC (Application Specific Integrated Circuit).

What is claimed is:

1. A non-transitory computer-readable storage medium storing a set of program instructions for a computer, the set of program instructions, when executed by the computer, causing the computer to perform:
acquiring target image data indicating a target image including an object of an inspection target, the target image data being generated by using an image sensor;
inputting the target image data into an image generation model to generate first reproduction image data, the first reproduction image data indicating a first reproduction image corresponding to the target image, the image generation model being a machine learning model including an encoder configured to extract a feature of image data that is input and a decoder configured to generate image data based on the extracted feature;
generating first difference image data indicating a difference between the target image and the first reproduction image by using the target image data and the first reproduction image data;
inputting the first difference image data into a feature extraction model to generate first feature data indicating a feature of the first difference image data, the feature extraction model being a machine learning model including an encoder configured to extract a feature of image data that is input; and
detecting a difference between the object of the inspection target and an object of a comparison target by using the first feature data.

2. The non-transitory computer-readable storage medium according to claim 1, wherein the detecting includes detecting the difference between the object of the inspection target and the object of the comparison target by using the first feature data and reference data, the reference data being generated based on a plurality of second feature data, each of the plurality of second feature data being generated by using comparison image data indicating a comparison image including the object of the comparison target;
wherein the plurality of second feature data are generated by inputting respective ones of a plurality of second difference image data into the feature extraction model, each of the plurality of second difference image data indicating a difference between the comparison image and second reproduction image corresponding to the comparison image;
wherein the first feature data incudes a first feature vector that is calculated for each unit region of an image indicated by the first difference image data;
wherein the first feature vector is a vector having, as elements, values based on a plurality of feature maps that are acquired by inputting the first difference image data into the feature extraction model;
wherein each of the plurality of second feature data includes a second feature vector that is calculated for each unit region of an image indicated by one of the plurality of second difference image data;
wherein the second feature vector is a vector having, as elements, values based on a plurality of feature maps that are acquired by inputting each of the plurality of second difference image data into the feature extraction model;
wherein the reference data is data indicating an average vector and a covariance matrix of the second feature vector among the plurality of second feature data, the average vector and the covariance matrix being calculated for each unit region; and
wherein the detecting includes:
calculating a Mahalanobis distance for each unit region by using the first feature vector and the reference data; and
detecting a difference between the target image and the comparison image based on the Mahalanobis distance.

3. The non-transitory computer-readable storage medium according to claim 1, wherein the image generation model is trained by using a plurality of first training image data; and
wherein the plurality of first training image data are acquired by performing image processing on original image data indicating the object, the original image data being data used for producing the object.

4. The non-transitory computer-readable storage medium according to claim 3, wherein second reproduction image data indicating the second reproduction image is generated by inputting the comparison image data into the image generation model, the image generation model being trained by using the plurality of first training image data.

5. The non-transitory computer-readable storage medium according to claim 3, wherein the feature extraction model is trained by using a plurality of training difference image data; and
wherein each of the plurality of training difference image data indicates a difference between first image data and second image data, the first image data being generated by performing image processing on the original image data, the second image data being generated by inputting the first image data into the image generation model.

6. The non-transitory computer-readable storage medium according to claim 5, wherein the first image data includes defect-added image data that is generated by performing a defect addition process on the original image data, the defect addition process being a process of adding one of a plurality of types of defects to an image indicated by the original image data; and
wherein the feature extraction model is trained to discriminate a type of a defect included in an image indicated by the defect-added image data in response to input of one of the plurality of training difference image data, each of the plurality of training difference image data being generated by using the defect-added image data.

7. The non-transitory computer-readable storage medium according to claim 2, wherein the reference data is statistical data calculated by using the plurality of second feature data, the plurality of second feature data being calculated for respective ones of the plurality of second difference image data; and
wherein the detecting includes:
calculating a first evaluation value indicating a degree of difference between the target image and the comparison image by performing a particular calculation using the first feature data and the statistical data; and
detecting a difference between the target image and the comparison image by using the first evaluation value and maximum and minimum values of a second evaluation value, the second evaluation value being calculated by performing the particular calculation using the statistical data and each of a plurality of feature data, the plurality of feature data including the plurality of second feature data, the second evaluation value being calculated for each of the plurality of feature data.

8. The non-transitory computer-readable storage medium according to claim 1, wherein the set of program instructions, when executed by the computer, causes the computer to further perform:
inputting captured image data into an object detection model and identifying an object region including an object of an inspection target in a captured image, the captured image data indicating the captured image including the object of the inspection target, the captured image data being generated by using an image sensor; and
generating the target image data indicating the target image by using the captured image data, the target image including the identified object region, the target image being a part of the captured image,
wherein the generating the first reproduction image data includes generating the first reproduction image data by inputting the generated target image data into the image generation model;
wherein the object detection model is a machine learning model trained by using second training image data and region information, the second training image data indicating a training image including the object, the region information indicating a region in which the object in the training image is located;
wherein the second training image data is generated by using object image data indicating an object image and background image data indicating a background image, the second training image data indicating the training image that is acquired by combining the object image with the background image;
wherein the object image data is image data based on original image data indicating the object, the original image data being used for producing the object; and
wherein the region information is information generated based on position information indicating a composition position of the object image, the composition position being used for combining the object image with the background image.

9. The non-transitory computer-readable storage medium according to claim 8, wherein the object detection model is one machine learning model trained to identify both a first type object and a second type object;
wherein the image generation model includes a first image generation model and a second image generation model;
wherein the first image generation model is a machine learning model trained to generate reproduction image data indicating a reproduction image corresponding to an image including the first type object in response to input of image data indicating the image including the first type object;
wherein the second image generation model is a machine learning model trained to generate reproduction image data indicating a reproduction image corresponding to an image including the second type object in response to input of image data indicating the image including the second type object;
wherein the identifying the object region includes identifying the object region by using the one object detection model in both cases where the object of the inspection target is the first type object and where the object of the inspection target is the second type object; and
wherein the generating the first reproduction image data includes:
in a case where the object of the inspection target is the first type object, generating the first reproduction image data by using the first image generation model; and
in a case where the object of the inspection target is the second type object, generating the first reproduction image data by using the second image generation model.

10. The non-transitory computer-readable storage medium according to claim 9, wherein the feature extraction model includes a first feature extraction model and a second feature extraction model;
wherein the first feature extraction model is a machine learning model trained to generate feature data indicating a feature of difference image data in response to input of the difference image data, the difference image data being generated by using first-type image data and first-type reproduction image data, the first-type image data indicating an image including the first type object, the first-type reproduction image data indicating a reproduction image corresponding to the image including the first type object;
wherein the second feature extraction model is a machine learning model trained to generate feature data indicating a feature of difference image data in response to input of the difference image data, the difference image data being generated by using second-type image data and second-type reproduction image data, the second-type image data indicating an image including the second type object, the second-type reproduction image data indicating a reproduction image corresponding to the image including the second type object; and
wherein the generating the first feature data includes:
in a case where the object of the inspection target is the first type object, generating the first feature data by using the first feature extraction model; and
in a case where the object of the inspection target is the second type object, generating the first feature data by using the second feature extraction model.

11. The non-transitory computer-readable storage medium according to claim 8, wherein the image generation model is trained by using the object image data, the object image data being used for generating the second training image data; and
wherein the feature extraction model is trained by using difference image data, the difference image data being generated by using the object image data.

12. The non-transitory computer-readable storage medium according to claim 3, wherein the image processing includes at least a brightness correction process of changing a brightness of an image, a smoothing process of smoothing an image, a noise addition process of adding noise to an image, a rotation process of rotating an image, or a shift process of shifting an object in an image.

13. The non-transitory computer-readable storage medium according to claim 6, wherein the defect addition process is a process of adding an image of a scratch or stain to an image without a defect.

14. The non-transitory computer-readable storage medium according to claim 1, wherein the first feature data is a feature matrix including, as elements, feature vectors corresponding to respective pixels of an input image, a feature vector at a particular pixel being constituted by pixel values at the particular pixel in feature maps, the feature maps being output from layers of the encoder of the feature extraction model.

15. An inspection apparatus comprising:
a controller; and
a memory storing a set of program instructions, the set of program instructions, when executed by the controller, causing the inspection apparatus to perform:
acquiring target image data indicating a target image including an object of an inspection target, the target image data being generated by using an image sensor;
inputting the target image data into an image generation model to generate first reproduction image data, the first reproduction image data indicating a first reproduction image corresponding to the target image, the image generation model being a machine learning model including an encoder configured to extract a feature of image data that is input and a decoder configured to generate image data based on the extracted feature;
generating first difference image data indicating a difference between the target image and the first reproduction image by using the target image data and the first reproduction image data;
inputting the first difference image data into a feature extraction model to generate first feature data indicating a feature of the first difference image data, the feature extraction model being a machine learning model including an encoder configured to extract a feature of image data that is input; and
detecting a difference between the target image and a comparison image by using the first feature data and reference data, the reference data being data based on second feature data generated by using comparison image data indicating the comparison image, the second feature data being generated by inputting second difference image data into the feature extraction model, the second difference image data indicating a difference between the comparison image and a second reproduction image corresponding to the comparison image.
